(19) United States
(12) Patent Application Publication
(10) Pub. No.: US 2025/0220647 A1
(43) Pub. Date: Jul. 3, 2025

(54) RESOURCE CONFIGURATION METHOD AND APPARATUS, AND TERMINAL AND NETWORK SIDE DEVICE

(71) Applicant: VIVO MOBILE COMMUNICATION CO., LTD., Dongguan (CN)

(72) Inventors: Lihui WANG, Dongguan (CN); Xueming PAN, Dongguan (CN)

(21) Appl. No.: 19/086,181

(22) Filed: Mar. 21, 2025

Related U.S. Application Data
(63) Continuation of application No. PCT/CN2023/119940, filed on Sep. 20, 2023.

(30) Foreign Application Priority Data
Sep. 23, 2022 (CN) 202211170478.X

(51) Int. Cl. H04W 72/0446; H04L 5/00; H04L 5/14

(52) U.S. Cl. CPC H04W 72/0446; H04L 5/0044; H04L 5/14

(57) ABSTRACT

This application discloses a resource configuration method and apparatus, and a terminal and a network side device, belonging to the technical field of communications. The resource configuration method includes: receiving, by a terminal, sub-band full duplex SBFD configuration information indicated by a network side device, where the SBFD configuration information comprises at least one of the following: a quantity of SBFD patterns; a time-domain period for applying SBFD pattern, where the time-domain period includes at least one first time-domain unit; whether each of the first time-domain unit is configured with an SBFD pattern or not in the time-domain period for applying SBFD pattern; the SBFD pattern configured for each of the first time-domain unit in the time-domain period for applying SBFD pattern; and a quantity of the first time-domain unit comprised in the time-domain period for applying SBFD pattern.

### CROSS-REFERENCE TO RELATED APPLICATIONS

This application is a continuation of International Patent Application No. PCT/CN2023/119940, filed on Sep. 20, 2023, which claims the priority of the Chinese Patent Application No. 202211170478.X filed on Sep. 23, 2022, both of which are incorporated herein by reference in their entireties.

### TECHNICAL FIELD

This application belongs to the technical field of communications, and in particular to a resource configuration method and apparatus, a terminal and a network side device.

### BACKGROUND

At present, after a flexible/full duplex (flexible/full duplex, SBFD) pattern is configured for a terminal on a frequency domain and/or a time domain, the pattern will determine possible or potential used uplink resources and downlink resources.

### SUMMARY

Embodiments of this application provide a resource configuration method and apparatus, a terminal and a network side device.

In a first aspect, a resource configuration method is provided, and includes:
receiving, by a terminal, a dynamic signaling from a network side device, where the dynamic signaling indicates whether a sub-band full duplex SBFD pattern, configured by the network side device for a first time-domain unit by a semi-static signaling, takes effect; and
determining, by the terminal, available resources for the first time-domain unit according to the dynamic signaling and the SBFD pattern.

In a second aspect, a resource configuration apparatus is provided, and includes:
a receiving module, configured to receive a dynamic signaling from a network side device, the dynamic signaling indicating whether a sub-band full duplex SBFD pattern, configured by the network side device for a first time-domain unit by a semi-static signaling, takes effect; and
a processing module, configured to determine available resources for the first time-domain unit according to the dynamic signaling and the SBFD pattern.

In a third aspect, a resource configuration method is provided, and includes:
sending, by a network side device, a dynamic signaling to a terminal, where the dynamic signaling indicates whether a sub-band full duplex SBFD pattern, configured by the network side device for a first time-domain unit by a semi-static signaling, takes effect or not.

In a fourth aspect, a resource configuration apparatus is provided, and includes:
a sending module, configured to send a dynamic signaling to a terminal, where the dynamic signaling indicates whether a sub-band full duplex SBFD pattern, configured by the network side device for a first time-domain unit by a semi-static signaling, takes effect or not.

In a fifth aspect, a terminal is provided. The terminal includes a processor and a memory. The memory stores a program or instruction runnable on the processor, and when executed by the processor, the program or instruction implements the steps of the method according to the first aspect.

In a sixth aspect, a terminal is provided, and includes a processor and a communication interface. The communication interface is configured to receive a dynamic signaling from a network side device, the dynamic signaling indicates whether a sub-band full duplex SBFD pattern, configured by the network side device for a first time-domain unit by a semi-static signaling, takes effect, and the processor is configured to determine available resources for the first time-domain unit according to the dynamic signaling and the SBFD pattern.

In a seventh aspect, a network side device is provided, and the network side device includes a processor and a memory. The memory stores a program or instruction runnable on the processor, and when executed by the processor, the program or instruction implements the steps of the method according to the third aspect.

In an eighth aspect, a network side device is provided, and includes a processor and a communication interface. The communication interface is configured to send a dynamic signaling to a terminal, and the dynamic signaling indicates whether a sub-band full duplex SBFD pattern, configured by the network side device for a first time-domain unit by a semi-static signaling, takes effect or not.

In a ninth aspect, a resource configuration system is provided, and includes: a network side device and a terminal. The terminal may be configured to implement the steps of the resource configuration method according to the first aspect, and the network side device may be configured to implement the steps of the resource configuration method according to the third aspect.

In a tenth aspect, a readable storage medium is provided. The readable storage medium has a program or instruction stored thereon, where when executed by a processor, the program or instruction implements the steps of the method according to the first aspect or implements the steps of the method according to the third aspect.

In an eleventh aspect, a chip is provided. The chip includes a processor and a communication interface, the communication interface is coupled to the processor, and the processor is configured to run a program or instruction to implement the method according to the first aspect or implement the method according to the third aspect.

According to a twelfth aspect, a computer program/program product is provided. The computer program/program product is stored in a storage medium, and the computer program/program product is executed by at least one processor to implement the steps of the resource configuration method according to the first aspect or implement the steps of the resource configuration method according to the third aspect.

### BRIEF DESCRIPTION OF THE DRAWINGS

FIG. 1 is a block diagram of an applicable wireless communication system according to an embodiment of this application;

FIG. 2 is a schematic diagram of configuring a time domain resource;

FIG. 3 is a schematic diagram of an SBFD pattern;

FIG. 4 is a schematic diagram of time division duplexing (Time Division Duplexing, TDD) configuration;

FIG. 5 is a schematic diagram of semi-static SBFD pattern configuration based on TDD configuration;

FIG. 6 is a schematic flowchart of a terminal side resource configuration method according to an embodiment of this application;

FIG. 7 is a schematic diagram of multiple SBFD patterns according to an embodiment of this application;

FIG. 8 is a schematic diagram of configuring an SBFD pattern for a first time-domain unit according to an embodiment of this application;

FIG. 9 is a schematic diagram of explicit configuration of a period for applying SBFD pattern according to an embodiment of this application;

FIG. 10 is a schematic diagram of SBFD patterns applied to a slot according to an embodiment of this application;

FIG. 11 is a schematic diagram showing a dynamic instruction indicates that an SBFD pattern takes effect according to an embodiment of this application;

FIG. 12 is a schematic diagram showing dynamic instruction confliction according to an embodiment of this application;

FIG. 13 is a schematic diagram showing no dynamic instruction confliction according to an embodiment of this application;

FIG. 14 is a schematic flowchart of a network side device side resource configuration method according to an embodiment of this application;

FIG. 15 is a schematic structure diagram of a terminal side resource configuration apparatus according to an embodiment of this application;

FIG. 16 is a schematic structure diagram of a network side device side resource configuration apparatus according to an embodiment of this application;

FIG. 17 is a schematic structure diagram of a communication device according to an embodiment of this application;

FIG. 18 is a schematic structure diagram of a terminal according to an embodiment of this application; and

FIG. 19 is a schematic structure diagram of a network side device according to an embodiment of this application.

### DETAILED DESCRIPTION

The technical solutions in embodiments of this application will be clearly described below with the reference to the accompanying drawings in the embodiments of this application. Apparently, the described embodiments are merely some rather than all of the embodiments of this application. All other embodiments obtained by a person of ordinary skill in the art based on the embodiments of this application shall fall within the protection scope of this application.

The terms such as “first”, “second”, and the like in the description and claims of this application are used for distinguishing similar objects and not necessarily used for describing the particular order or sequence. It should be understood that used terms may be interchangeable under appropriate circumstances, so that the embodiment of this application may be implemented in a sequence other than those illustrated or described in the figures or by texts. In addition, the objects distinguished by “first” or “second” are generally objects of one type with the unlimited object quantity. For example, a first object may indicate one or more first objects. In addition, “and/or” in the specification and the claims represents at least one of connected objects, and character “/” generally represents an “or” relationship between associated objects before and after.

It is worth pointing out that the technology described in embodiments of this application is not limited to a long term evolution (Long Term Evolution, LTE)/LTE-advanced (LTE-Advanced, LTE-A) system, and may also be used in other wireless communication systems, such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA) and other systems. The terms “system” and “network” in embodiments of this application are often used interchangeably, and the described technology may be applied to the systems and radio technologies mentioned above, and may also be applied to other systems and radio technologies. The following descriptions describe a new radio (New Radio, NR) system for an illustration purpose, and NR terminology is used in most of the following descriptions, but these technologies may also be applied to applications other than NR system applications, such as 6th generation (6th Generation, 6G) communication systems.

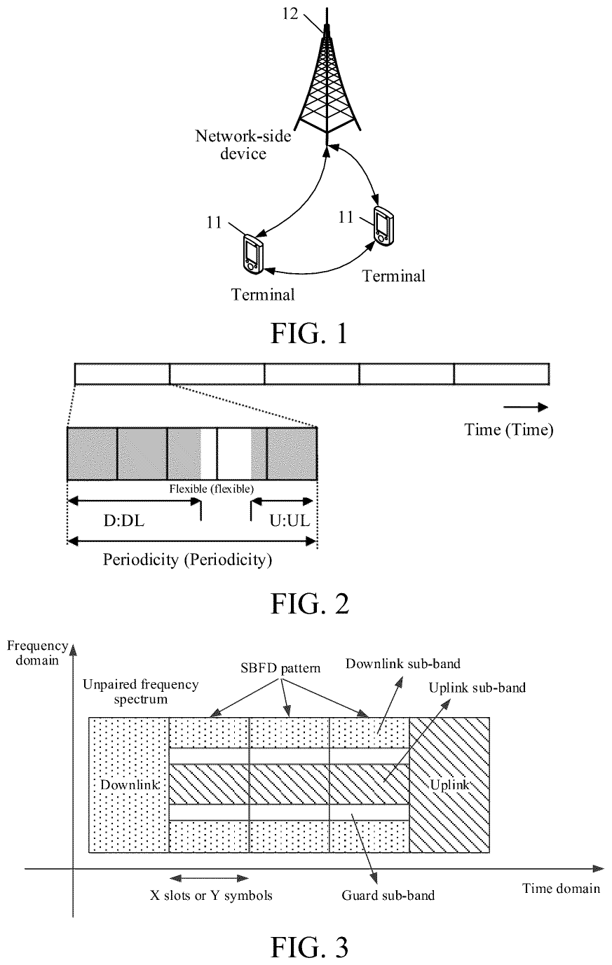

FIG. 1 is a block diagram of an applicable wireless communication system according to an embodiment of this application. The wireless communication system includes a terminal 11 and a network side device 12. The terminal 11 may be a terminal side device such as a mobile phone, a tablet personal computer (Tablet Personal Computer), a laptop computer (Laptop Computer) which is also referred to as a notebook computer, a personal digital assistant (Personal Digital Assistant, PDA), a palmtop computer, a netbook, an ultra-mobile personal computer (ultra-mobile personal computer, UMPC), a mobile internet device (Mobile Internet Device, MID), an augmented reality (augmented reality, AR)/virtual reality (virtual reality, VR) device, a robot, a wearable device (Wearable Device), vehicular user equipment (Vehicle User Equipment, VUE), pedestrian user equipment (Pedestrian User Equipment, PUE), a smart home (a home device with a wireless communication function, for example, a refrigerator, a television, a washing machine, or furniture), a games console, a personal computer (personal computer, PC), a teller machine, and a self-service machine. The wearable device includes: a smartwatch, a smart band, a smart headset, smart glasses, smart jewelry (a smart bracelet, a smart chain bracelet, a smart ring, a smart necklace, a smart anklet, a smart ankle chain, and the like), a smart wrist strap, a smart garment, and the like. It should be noted that a specific type of the terminal 11 is not limited in the embodiments of this application. The network side device 12 may include an access network device or a core network device. The access network device may also be referred to as a radio access network device, a radio access network (Radio Access Network, RAN), a radio access network function, or a radio access network unit. The access network device may include a base station, a wireless local area network (Wireless Local Area Network, WLAN) access point or a wireless fidelity (Wireless Fidelity, WiFi) node, and the like. The base station may be referred to as a node B, an evolved node B (Evolved Node B, eNB), an access point, a base transceiver station (Base Transceiver Station, BTS), a radio base station, a radio transceiver, a basic service set (Basic Service Set, BSS), an extended service set (Extended Service Set, ESS), a household node B, a household evolved node B, a transmission reception point (Transmission Reception Point, TRP) or some other appropriate terms in the field provided that the same technical effect is achieved. The base station is not limited to specific technical vocabularies. It is to be noted that in embodiments of this application, illustration is only provided by taking the base station in the NR system as an example, and the specific type of base station is not limited.

The uplink and downlink slot configuration in NR depends on the time division duplex uplink downlink common configuration signaling (TDD-UL-DL-ConfigCommon), the time division duplex uplink downlink dedicated configuration signaling (TDD-UL-DL-ConfigDedicated) and a slot format indicator (Slot Format Indicator, SFI), (i.e., the slot configuration signaling carried by DCI format (format) 2_0), as shown in FIG. 2.

The TDD-UL-DL-ConfigurationCommon is in cell level configuration, and is generally configured by cell system information such as cell access information and SIB (except for SIB1) scheduling information (System Information Block1, SIB1), the TDD-UL-DL-ConfigurationDedicated is in user equipment (User Equipment, UE) dedicated configuration, but this configuration may only achieve the modification of a flexible symbol (Flexible Symbol) in the TDD-UL-DL-ConfigurationCommon configuration, and may not achieve the conversion a downlink of symbol indicated by the TDD-UL-DL-ConfigurationCommon into an uplink symbol, or conversion of an uplink symbol into a downlink symbol.

The Flexible Symbol is a symbol acquired by removal of configured uplink and downlink slot and/or uplink and downlink symbol number in the Periodicity configured by the TDD-UL-DL-ConfigurationCommon and/or TDD-UL-DL-ConfigurationDedicated.

The SFI indicates the uplink and downlink slot format change through DCIformat 2_0. It is specified in relevant protocols that: for a group of symbols indicated as a downlink by the TDD-UL-DL-ConfigurationCommon or the TDD-UL-DL-ConfigurationDedicated, the terminal is not expected to detect a symbol set of a slot indicated by the DCI format 2_0 value with an SFI-index field to be uplink or flexible; and for a group of symbols indicated as an uplink by the TDD-UL-DL-ConfigurationCommon or the TDD-UL-DL-ConfigurationDedicated, the terminal is not expected to detect the symbol set of the slot indicated by the DCI format 2_0 value with the SFI-index field to be downlink or flexible.

A current network deployed spectrum system is fixed, and mainly includes the following two types:
TDD: time division duplexing (Time Division Duplexing, TDD), a radio frequency point is shared for receiving and transmission, and the uplink and downlink use different slots for communication; and
FDD: frequency division duplexing (Frequency Division Duplexing, FDD), different radio frequency points are used for receiving and transmission for communication.

The two systems have respective advantages and disadvantages. The uplink and downlink of the TDD system are distinguished by time, and a frequency band with a symmetrical bandwidth is not required, so the TDD may use fragmentary frequency bands, and it is suitable for traffic with obviously asymmetrical uplink and downlink. However, this is unfavorable for time delay-sensitive traffic. In addition, the transmission time of the TDD aiming at a certain transmission direction is only about a half of that of the FDD, so the coverage or throughput capacity is limited. In a case that the FDD system supports asymmetrical traffic, the frequency spectrum utilization rate will be greatly reduced. Therefore, the use requirement of future mobile communication on the frequency spectrum is more flexible. The network side flexible/full duplex (flexible/full duplex) and the user/terminal side half duplex operation may improve the frequency spectrum utilization rate, improve the uplink coverage and reduce the delay of the time delay-sensitive traffic.

The characteristics of the network side flexible/full duplex (flexible/full duplex, also referred to as SBFD) and user/terminal side half duplex operation include the following:

Different frequency domain resources on some slots/symbols of the TDD may be semi-statically configured into resources achieving both uplink transmission and downlink receiving, as shown in FIG. 3.

Network side full duplex: downlink sending and uplink receiving may be performed at the same time at the network side.

User/terminal side half duplex: the terminal may only perform uplink sending or downlink receiving at a certain moment. The terminal does not support simultaneous downlink sending and uplink receiving.

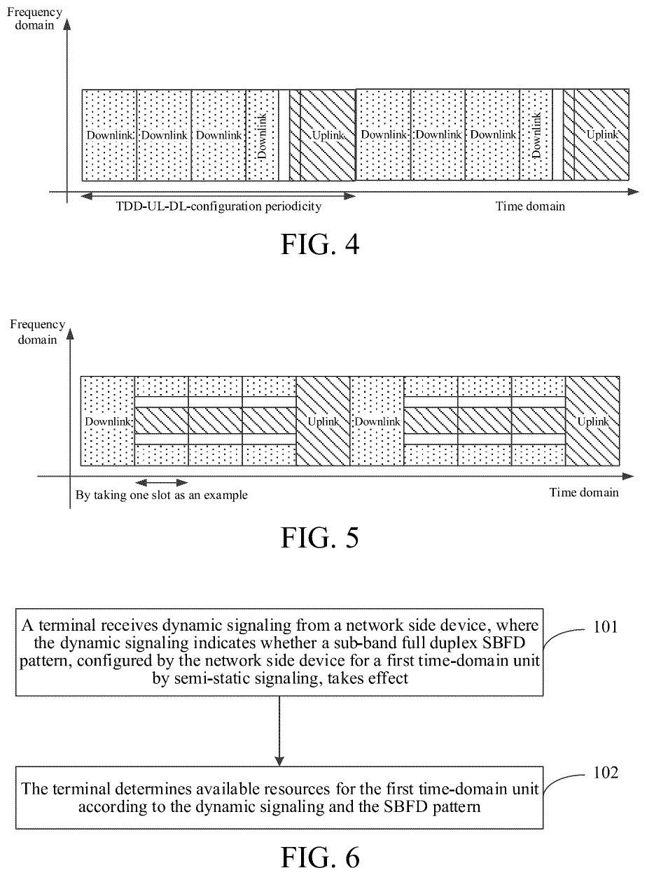

In conventional TDD configuration, as shown in FIG. 4, uplink and downlink transmission configuration is performed in the time-domain direction.

As shown in FIG. 5, based on the conventional TDD configuration, the semi-static SBFD pattern (pattern) configuration may be performed.

The following symbol types are defined in this embodiment:

Semi-static DL and Semi-static UL: downlink symbol and uplink symbol configured by the TDD-UL-DL-ConfigurationCommon and/or TDD-UL-DL-ConfigDedicated.

Semi-static F: flexible symbol F configured by the TDD-UL-DL-ConfigurationCommon and/or TDD-UL-DL-ConfigDedicated; or in a case that the TDD-UL-DL-ConfigurationCommon and TDD-UL-DL-ConfigDedicated signaling is not provided for the UE, the UE considers that all symbols are Semi-static F.

Radio resource control (Radio Resource Control, RRC) downlink (downlink, DL): corresponding to downlink transmission in higher-level configuration on Semi-static F, such as a physical downlink control channel (Physical Downlink Control Channel, PDCCH), or a physical downlink shared channel (Physical Downlink Shared Channel, PDSCH), such as a semi-persistent scheduling (Semi-PersistentScheduling, SPS) PDSCH, or a downlink reference signal such as a channel state information reference signal (Channel State Information Reference Signal, CSI-RS), a tracking reference signal (Tracking Reference Signal, TRS) or a positioning reference signal (PRS).

RRC UL: corresponding to uplink transmission in higher-level configuration on Semi-static F, such as a sounding reference signal (Sounding Reference Signal, SRS), or a physical uplink control channel (Physical Uplink Control Channel, PUCCH), or a physical uplink shared channel (Physical Uplink Shared Channel, PUSCH), or a physical random access channel (Physical Random Access Channel, PRACH).

Dynamic (Dynamic) DL and Dynamic UL: corresponding to symbols scheduled into uplink or downlink by DCI format except for DCI format 2_0 at Semi-static F.

At present, after the SBFD pattern is configured for the terminal on the frequency domain and/or time domain, the pattern will determine the possible/potential used uplink (uplink, UL) and downlink (DL) resources, and the SBFD pattern is semi-statically configured, and may not change within a long period of time. Generally, the uplink and downlink traffic of the UE are asymmetric, in some scenarios, the UL traffic volume is greater than the DL traffic volume, but for some other scenarios, the DL traffic volume is greater than the UL traffic volume. For example, at some moments, the DL traffic volume of the whole system is high, the DL resources are short, but the utilization rate of the UL resources is low, and many UL resources are free, so the resource utilization rate of the system is low. Therefore, according to embodiments of this application, in the semi-static configuration of the SBFD pattern on the frequency domain and the time domain, a method of dynamically indicating whether the SBFD pattern starts to be used on the semi-static configuration time domain or not, or a method of indicating whether the SBFD pattern takes effect/is applied to the semi-static configuration time domain or not is designed to better match the uplink and downlink traffic volume for improving the resource utilization rate.

Detailed illustration about the resource configuration method provided by embodiments of this application will be provided below through some embodiments and application scenarios in combination with accompanying drawings.

Embodiments of this application provide a resource configuration method. As shown in FIG. 6, the method includes:

Step 101: A terminal receives a dynamic signaling from a network side device, and the dynamic signaling indicates whether a sub-band full duplex SBFD pattern, configured by the network side device for a first time-domain unit by a semi-static signaling, takes effect.

Step 102: The terminal determines available resources for the first time-domain unit according to the dynamic signaling and the SBFD pattern.

In embodiments of this application, after the SBFD pattern is configured for the terminal by the semi-static signaling, the network side device indicates whether the SBFD pattern takes effect or not through the dynamic signaling. Therefore, the resource configuration may be dynamically adjusted according to the dynamic signaling, and the resource utilization rate may be improved.

In this embodiment, the first time-domain unit may be one or more slots, and may also be one or more symbols. For example, the first time-domain unit may include X slots and/or Y symbols, a quantity X of the slots or a quantity Y of the symbols included by the first time-domain unit is configured by the network side device or defined by a protocol. The X and the Y are both greater than or equal to one.

In some embodiments, the method further includes:
the terminal receives SBFD configuration information indicated by the semi-static (Semi-static) signaling, and the SBFD configuration information includes at least one of the following:
a quantity of SBFD patterns, where a quantity of the SBFD patterns is greater than or equal to one, each SBFD pattern has a unique identifier, for example, in a case that there is J SBFD patterns, the identifier of the j^{th} SBFD pattern is j−1, j is greater than or equal to one but less than or equal to J, and J is an integer greater than one;
a time-domain period for applying SBFD pattern, where the time-domain period includes at least one first time-domain unit, the time-domain period for applying SBFD pattern may be explicitly configured by the network side device, or determined by the DL-UL-TransmissionPeriodicity (downlink-uplink-transmission periodicity), in a case that only pattern1 is configured by the TDD-UL-DL-ConfigurationCommon, the DL-UL-TransmissionPeriodicity configured in the pattern1 is used; and if pattern1 and pattern2 are configured by the TDD-UL-DL-ConfigurationCommon, the DL-UL-TransmissionPeriodicity of DL-UL-TransmissionPeriodicity+pattern2 in pattern1 is used, and preferably, if the time-domain period for applying SBFD pattern is not explicitly configured, the SBFD pattern is applied to each slot and/or each symbol;
whether each of the first time-domain unit is configured with the SBFD pattern or not in the time-domain period for applying SBFD pattern, including whether the first tome-domain unit uses a potential SBFD pattern or use the downlink resource, uplink resource and/or flexible resource configured by the TDD-UL-DL-ConfigurationCommon and/or TDD-UL-DL-ConfigDedicated;
the SBFD pattern configured for each of the first time-domain unit in a time-domain period for applying SBFD pattern, where each first time-domain unit may be configured with one or more SBFD patterns; and
the first time-domain units included in the time-domain period for applying SBFD pattern and a quantity of the first time-domain unit, where they may be explicitly configured by the network side device, the time-domain period for applying SBFD pattern may include one or more first time-domain units, for example, may include one or more slots, one or more OFDM symbols, or may include at least one of the following configured by the TDD-UL-DL-ConfigurationCommon and/or TDD-UL-DL-ConfigDedicated and/or indicated by DCI format2_0: a downlink slot, a downlink symbol, an uplink slot, an uplink symbol, a flexible slot, and a flexible symbol.

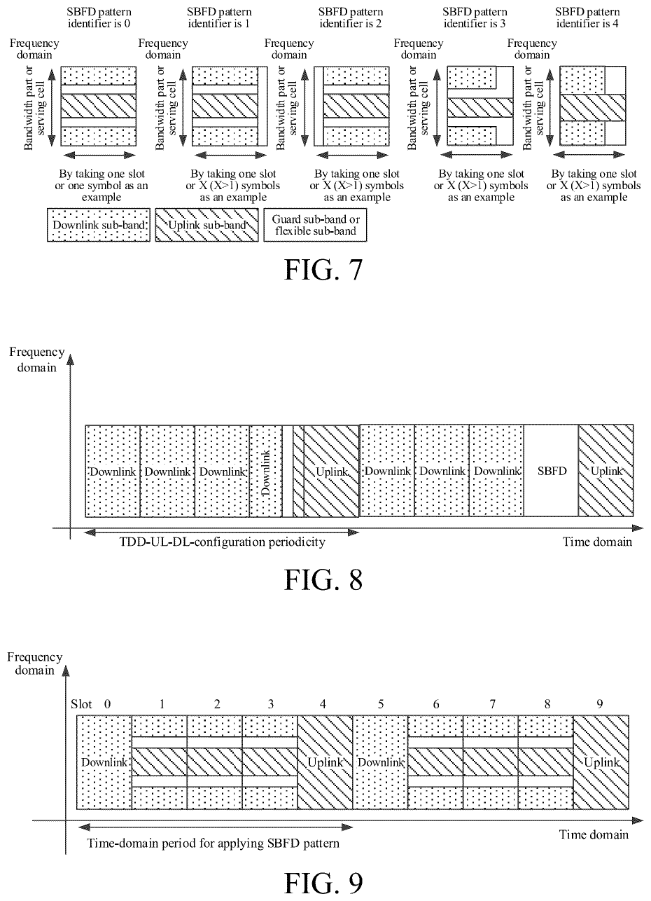

In a specific example, as shown in FIG. 7, the terminal may be configured with five SBFD patterns (pattern), the identifier (Identifier, id) of the first SBFD pattern is zero, the identifier (id) of the second SBFD pattern is one, the identifier (id) of the third SBFD pattern is two, the identifier (id) of the fourth SBFD pattern is three, and the identifier (id) of the fifth SBFD pattern is four. It can be seen that the first SBFD pattern application first time-domain unit includes one slot and one symbol. By aiming at the bandwidth part or serving cell configuration, the first SBFD pattern indicates the uplink sub-band, the downlink sub-band and the guard sub-band. The second SBFD pattern application first time-domain unit includes one slot or X symbols, and the X is greater than one. By aiming at the bandwidth part or serving cell configuration, the second SBFD pattern indicates the uplink sub-band, the downlink sub-band and the guard sub-band. The latter half part of the first time-domain unit further includes uplink and downlink conversion time. The third SBFD pattern application first time-domain unit includes one slot or X symbols, and the X is greater than one. By aiming at the bandwidth part or serving cell configuration, the third SBFD pattern indicates the uplink sub-band, the downlink sub-band and the guard sub-band. The former half part of the first time-domain unit further includes uplink and downlink conversion time. The fourth SBFD pattern application first time-domain unit includes one slot or X symbols, and the X is greater than one. By aiming at the bandwidth part or serving cell configuration, the fourth SBFD pattern indicates the uplink sub-band, the downlink sub-band and the guard sub-band. The latter half part of the first time-domain unit further includes uplink and downlink conversion time. The fifth SBFD pattern application first time-domain unit includes one slot or X symbols, and the X is greater than one. By aiming at the bandwidth part or serving cell configuration, the fifth SBFD pattern indicates the uplink sub-band, the downlink sub-band and the guard sub-band. The latter half part of the first time-domain unit further includes uplink and downlink conversion time.

As shown in FIG. 8, in the time-domain period for applying SBFD pattern and the time-domain period for SBFD pattern, whether the potential SBFD pattern occurs or is used or not may be indicated on the slot and/or the OFDM symbol. In some specific examples, as shown in FIG. 9, the network side device explicitly configures the time-domain period for applying SBFD pattern, and potential SBFD patterns occur on slots (slot) 1, 2, and

In this embodiment, the terminal needs to acquire the SBFD configuration information indicated by the network side device in advance, and the SBFD configuration information is used for configuring at least one of the above in the uplink and/or downlink transmission direction. One or more SBFD patterns may be configured for each or some of the first time-domain units by the semi-static signaling. Then, whether the SBFD pattern configured for the first time-domain unit takes effect or not and which SBFD pattern takes effect may be indicated through the dynamic signaling, that is, the available resources of the terminal may be dynamically adjusted according to the downlink traffic volume and uplink traffic volume, the uplink and downlink traffic volume may be better matched, and the resource utilization rate may be improved.

In some embodiments, the SBFD pattern indicates at least one of the following of a serving cell (serving cell) or a carrier wave or a bandwidth part (BandWidth Part, BWP):
location information of an uplink frequency domain resource, including but not limited to a starting location, an ending location, a total number of occupied resource blocks (Resource Block, RB), and the like of the uplink frequency domain resource;
location information of a downlink frequency domain resource, including but not limited to a starting location, an ending location, a total number of occupied resource blocks, and the like of the downlink frequency domain resource;
location information of a guard frequency domain resource (guardband), including but not limited to a starting location, an ending location, a total number of occupied resource blocks, and the like of the guard frequency domain resource; and
location information of a flexible frequency domain resource, including but not limited to a starting location, an ending location, a total number of occupied resource blocks, and the like of the flexible frequency domain resource. The flexible frequency domain resource is used for at least one of the following:
a downlink frequency domain resource;
an uplink frequency domain resource;
an interference measurement resource; and
a guard frequency domain resource.

In this embodiment, the SBFD pattern configured for the terminal by the semi-static signaling is a potential SBFD pattern on the first time-domain unit, the SBFD pattern may take effect or may not take effect, and whether the SBFD pattern takes effect or not needs to be further indicated by the dynamic signaling.

In some embodiments, within the time-domain period for applying SBFD pattern, the SBFD patterns configured for different first time-domain units are different or the same, for example, by considering adjacent channel interference, the SBFD patterns applied in the semi-static (Semi-static) downlink symbol, the flexible symbol and the uplink symbol may be different.

In some embodiments, the SBFD pattern available for use by the terminal in the first time-domain unit is determined by at least one of the following:
configuration information of a previous first time-domain unit adjacent to the first time-domain unit, for example, whether the previous first time-domain unit is configured with the potential SBFD pattern or not, if it is configured with the SBFD pattern, what SBFD pattern it is configured with, and if not, whether the previous first time-domain unit is configured into a downlink resource by the semi-static signaling or not, whether the previous first time-domain unit is configured into an uplink resource or not by the semi-static signaling, or whether the previous first time-domain unit is configured into a flexible resource or not by the semi-static signaling;
configuration information of a subsequent first time-domain unit adjacent to the first time-domain unit, for example, whether the subsequent first time-domain unit is configured with the potential SBFD pattern or not, if it is configured with the SBFD pattern, what SBFD pattern it is configured with, and if not, whether the subsequent first time-domain unit is configured into a downlink resource by the semi-static signaling or not, whether the subsequent first time-domain unit is configured into an uplink resource or not by the semi-static signaling, or whether the subsequent first time-domain unit is configured into a flexible resource or not by the semi-static signaling;
whether the first time-domain unit includes a flexible symbol configured by the semi-static signaling or not; and
whether the first time-domain unit is configured to include an uplink and downlink conversion symbol or not, for example, whether an uplink and downlink conversion point exists or not is judged according to the slot format configured by the TDD-UL-DL-ConfigurationCommon and/or TDD-UL-DL-ConfigDedicated.

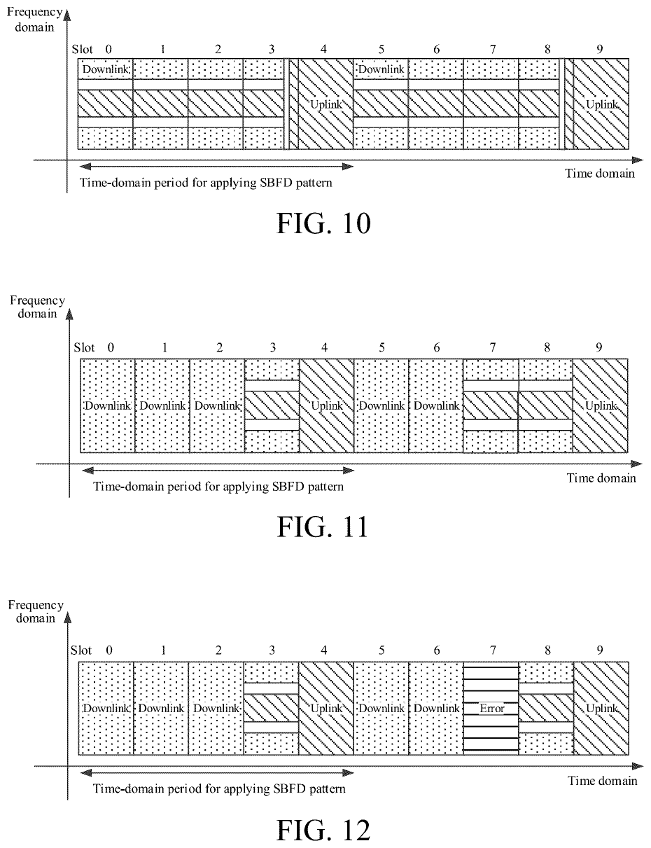

Which SBFD pattern is used in a slot with the potential SBFD pattern is determined by the UE according to conditions. In a specific example, as shown in FIG. 10, in one time-domain period for applying SBFD pattern, the potential SBFD pattern occurs on the downlink slot and/or symbol configured by the TDD-UL-DL-ConfigurationCommon and/or TDD-UL-DL-ConfigDedicated. On the slot 3 as shown in FIG. 10, an uplink and downlink conversion point exists due to judgment according to the slot format configured by the TDD-UL-DL-ConfigurationCommon and/or TDD-UL-DL-ConfigDedicated, so the SBFD pattern uses the SBFD pattern with the id being one as shown in FIG. 7. However, for the slots 0, 1, and 2, no uplink and downlink conversion point exists, so the SBFD pattern uses the SBFD pattern with the id being zero as shown in FIG. 7.

In some embodiments, the semi-static signaling is system information or a cell common signaling, a subcarrier space (subcarrier space, SCS) used by the SBFD pattern is equal to or greater than a first SCS, and the first SCS is an SCS configured by a time division duplex uplink downlink common configuration signaling TDD-UL-DL-ConfigCommon. By using the system information and/or cell common signaling as the semi-static signaling, the SBFD resource may also be applied to a competition-based random access process and/or initial access, the application field of the SBFD is expanded, and the signaling expenditure is reduced. The SCS uses the above configuration, so the frequency domain resource granularity of the SBFD may be clear, the compatibility with the SCS configured by the TDD-UL-DL-ConfigCommon may be realized, and the frequency domain resource granularity of the SBFD may be finer.

In some embodiments, the semi-static signaling is a radio resource control RRC message, through the specific RRC message of the terminal, the SBFD pattern may be configured for each serving cell, or the SBFD pattern may be configured for each BWP of each serving cell, and
the SCS used by the SBFD pattern is the same as an SCS of the initial downlink or uplink bandwidth part of the serving cell configured with the SBFD pattern; or
the SCS used by the SBFD pattern is the same as an SCS of an active downlink or uplink bandwidth part configured with the SBFD pattern; or
the SCS used by the SBFD pattern is independently configured by the network side device.

Therefore, the UE may make the frequency domain resource granularity of the SBFD clear. In a case that the SCS is the same as an SCS of the initial downlink or uplink bandwidth part or active downlink or uplink bandwidth part of the serving cell, the operation is simple. In a case that the SCS is independently configured by the network side device, the configuration of the frequency domain resource granularity of the SBFD is flexible.

In some embodiments, the available resources for the first time-domain unit include at least one of the following:
a downlink sub-band indicated by the SBFD pattern;
an uplink sub-band indicated by the SBFD pattern;
a flexible sub-band indicated by the SBFD pattern; and
a guard sub-band indicated by the SBFD pattern.

In this embodiment, the network side device indicates whether the potential SBFD pattern of the first time-domain unit takes effect or not through the dynamic signaling, i.e., whether the resource indicated by the SBFD pattern is available/valid (available/valid) or not. This may also be expressed as effective, taking effect, or being usability, and the meaning of the available resource refers to that the data, reference signal and control channel transmission and monitoring may be performed on the resource. For example, that the downlink sub-band is available means that the downlink data, reference signal and control channel reception and monitoring may be performed on the downlink sub-band, that the uplink sub-band is available means that the uplink data, reference signal and control channel transmission may be performed on the uplink sub-band, that the flexible sub-band is available means that the flexible sub-band may be used as a downlink frequency domain resource or uplink frequency domain resource or interference measurement resource or guard frequency domain resource, and that the guard sub-band is available means that the guard sub-band may not perform uplink data signal sending and downlink data signal reception.

Identically, the unavailable may be expressed as invalid or unusable, and the unavailable resource means that the data, reference signal and control channel transmission and monitoring may not be performed on the resource. For example, that the downlink sub-band is unavailable means that the downlink data, reference signal and control channel reception and monitoring may not be performed on the downlink sub-band, that the uplink sub-band is unavailable means that the uplink data, reference signal and control channel transmission may not be performed on the uplink sub-band, that the flexible sub-band is unavailable means that the flexible sub-band may not be used as a downlink frequency domain resource or uplink frequency domain resource or interference measurement resource or guard frequency domain resource, and that the guard sub-band is unavailable means that the guard sub-band may perform uplink data signal sending and downlink data signal reception.

That the SBFD pattern takes effect may refers to that some resources indicated by the SBFD pattern are available, and may also refer to that all resources indicated by the SBFD pattern are available.

In this embodiment, the dynamic signaling includes at least one of a layer 1 signaling and a layer 2 signaling, and may also be a newly defined signaling, for example, at a newly defined downlink control information (Downlink Control Information, DCI) format, and the DCI format may be a UE-specific (UE-specific) or group-common (group-common) physical downlink control channel (PDCCH). In a case that the newly defined signaling is group-common PDCCH, the signaling design is similar to that of DCI format 0_2. Or, a new media access control (Media Access Control, MAC) control element (Control Element, CE) may be defined to be used as the dynamic signaling. In a case that an existing signaling is used as the dynamic signaling, the dynamic signaling may use DCI format 2_0. Additionally, the format of the dynamic signaling needs to be determined in combination with the terminal capability. In a case that the terminal does not support DCI format 2_0, the dynamic signaling may be the above newly defined signaling or UE-specific DCI format(s). In a case that the terminal supports DCI format 2_0, the dynamic signaling may be in DCI format 2_0.

In some embodiments, the operation that the terminal determines available resources for the first time-domain unit according to the dynamic signaling and the SBFD pattern includes any one of the following:
the dynamic signaling is in a downlink control information DCI format 2_0, and the terminal determines whether a resource indicated by the SBFD pattern is available or not according to a transmission direction of the first time-domain unit configured by the semi-static signaling and indication of a format index in the dynamic signaling. The format index may indicate the uplink (U), the downlink (D), the flexible resource F or the first value, the first value is a preset value, for example, may be 255, and may further be another value set according to requirements.

In a case that the dynamic signaling is terminal dedicated DCI and/or RRC message, and the terminal determines whether the resource indicated by the SBFD pattern is available or not according to a transmission direction of the first time-domain unit scheduled or configured by the dynamic signaling. The transmission direction scheduled or configured by the dynamic signaling includes uplink and downlink.

In some embodiments, the operation that the terminal determines whether a resource indicated by the SBFD pattern is available or not according to a transmission direction of the first time-domain unit configured by the semi-static signaling and indication of a format index in the dynamic signaling includes at least one of the following:
in a case that the first time-domain unit is configured into the downlink resource by the semi-static signaling, and the format index (format index) in the dynamic signaling indicates uplink (U), determining that the uplink sub-band indicated by the SBFD pattern is available;
in a case that the first time-domain unit is configured into the downlink resource by the semi-static signaling, and the format index in the dynamic signaling indicates downlink (D), determining that the uplink sub-band indicated by the SBFD pattern is unavailable;
in a case that the first time-domain unit is configured into the downlink resource by the semi-static signaling, and the format index in the dynamic signaling indicates a flexible resource F or a first value, determining that the uplink sub-band indicated by the SBFD pattern is unavailable;
in a case that the first time-domain unit is configured into the downlink resource by the semi-static signaling, and the format index in the dynamic signaling indicates the flexible resource F or the first value, determining that the uplink sub-band indicated by the SBFD pattern is available;
in a case that the first time-domain unit is configured into an uplink resource by the semi-static signaling, and the format index in the dynamic signaling indicates downlink, determining that a downlink sub-band indicated by the SBFD pattern is available;
in a case that the first time-domain unit is configured into the uplink resource by the semi-static signaling, and the format index in the dynamic signaling indicates uplink, determining that the downlink sub-band indicated by the SBFD pattern is unavailable;
in a case that the first time-domain unit is configured into the uplink resource by the semi-static signaling, and the format index in the dynamic signaling indicates the flexible resource F or the first value, determining that the downlink sub-band indicated by the SBFD pattern is unavailable;
in a case that the first time-domain unit is configured into the uplink resource by the semi-static signaling, and the format index in the dynamic signaling indicates the flexible resource F or the first value, determining that the uplink sub-band indicated by the SBFD pattern is available;
in a case that the first time-domain unit is configured into a flexible resource by the semi-static signaling, and the format index in the dynamic signaling indicates downlink, determining that the downlink sub-band indicated by the SBFD pattern is available;
in a case that the first time-domain unit is configured into the flexible resource by the semi-static signaling, and the format index in the dynamic signaling indicates downlink, determining that the downlink sub-band indicated by the SBFD pattern is unavailable;
in a case that the first time-domain unit is configured into the flexible resource by the semi-static signaling, and the format index in the dynamic signaling indicates downlink, determining that the resource indicated by the SBFD pattern is unavailable, and the downlink resource configured by the TDD-UL-DL-ConfigCommon and/or a time division duplex uplink downlink dedicated configuration signaling TDD-UL-DL-ConfigDedicated is available;
in a case that the first time-domain unit is configured into the flexible resource by the semi-static signaling, and the format index in the dynamic signaling indicates uplink, determining that the uplink sub-band indicated by the SBFD pattern is available;
in a case that the first time-domain unit is configured into the flexible resource by the semi-static signaling, and the format index in the dynamic signaling indicates uplink, determining that the uplink sub-band indicated by the SBFD pattern is unavailable;
in a case that the first time-domain unit is configured into the flexible resource by the semi-static signaling, and the format index in the dynamic signaling indicates uplink, determining that the resource indicated by the SBFD pattern is unavailable, and the uplink resource configured by the TDD-UL-DL-ConfigCommon and/or TDD-UL-DL-ConfigDedicated is available;
in a case that the first time-domain unit is configured into the flexible resource by the semi-static signaling, and the format index in the dynamic signaling indicates the flexible resource F or the first value, determining that the uplink sub-band indicated by the SBFD pattern is available;
in a case that the first time-domain unit is configured into the flexible resource by the semi-static signaling, and the format index in the dynamic signaling indicates the flexible resource F or the first value, determining that the uplink sub-band indicated by the SBFD pattern is unavailable;
in a case that the first time-domain unit is configured into the flexible resource by the semi-static signaling, and the format index in the dynamic signaling indicates the flexible resource F or the first value, determining that the downlink sub-band indicated by the SBFD pattern is available;
in a case that the first time-domain unit is configured into the flexible resource by the semi-static signaling, and the format index in the dynamic signaling indicates the flexible resource F or the first value, determining that the downlink sub-band indicated by the SBFD pattern is unavailable;
in a case that the first time-domain unit is configured into the flexible resource by the semi-static signaling, and the format index in the dynamic signaling indicates the flexible resource F or the first value, determining that the resource indicated by the SBFD pattern is available; and
in a case that the first time-domain unit is configured into the flexible resource by the semi-static signaling, and the format index in the dynamic signaling indicates the flexible resource F or the first value, determining that the resource indicated by the SBFD pattern is unavailable, and the flexible resource configured by the TDD-UL-DL-ConfigCommon and/or TDD-UL-DL-ConfigDedicated is available.

In a specific example, as shown in FIG. 9, the potential SBFD pattern configured by the semi-static signaling exists in slots 1, 2, 3, 6, 7, and 8, the dynamic signaling is DCI format 0_2, all symbols in the slots 1, 2, and 6 are indicated as D, as shown in FIG. 11, the potential SBFD pattern of the slots 1, 2, and 6 does not take effect, and the uplink sub-band is unavailable; and all symbols in the slots 3, 7, and 8 are indicated as U, the potential SBFD pattern of the slots 3, 7, and 8 takes effect, and the uplink sub-band is available.

In a specific example, the dynamic signaling is DCI format 2_0, the SBFD pattern is configured by the semi-static signaling on the downlink symbol, and that the terminal receives the DCI format 2_0 and determines the transmission direction according to the format index in the dynamic signaling includes any one of the following: the indication direction of the DCI format 2_0 is not used on the downlink sub-band of the downlink symbol, that is, the indication and/or content of the DCI format 2_0 are/is ignored by the UE on the downlink sub-band in the downlink symbol; and the indication and/or content of the DCI format 2_0 are/is applied to the uplink sub-band or flexible sub-band in the downlink symbol.

Specifically, as shown in Table 1:

TABLE 1

| | | | Transmission |
|---|---|---|---|
| | | | direction |
| | | | outside the |
| | | | sub-band, i.e., |
| | | Sub-band | transmission |
| | | transmission | direction of |
| Configuration | | direction | outside sub-band |
| direction of | Indication | determined | (Outside subband), |
| semi-static | direction | by UE after | determined by UE |
| sub-band | of format | receiving | after receiving |
| (Semistatic-subband) | index | format index | format index |
| U | U | U | D |
| U | F | U | D |
| U | F | F | D |
| U | F | D | D |
| U | D | D | D |
| F | F | F | D |
| F | D | D | D |
| F | U | U | D |
| D | D | D | NA |
| D | F | D | NA |
| D | U | D | NA |

It can be seen that in the downlink symbols, any one of the following conditions is included:
in a case that the sub-band is configured into the uplink resource by the semi-static signaling, and the format index in the dynamic signaling indicates U, the terminal determines the transmission direction of the sub-band to be uplink for uplink data transmission, and the outside sub-band is used for downlink data transmission;
in a case that the sub-band is configured into the uplink resource by the semi-static signaling, and the format index in the dynamic signaling indicates F, the terminal determines the transmission direction of the sub-band to be uplink for uplink data transmission, and the outside sub-band is used for downlink data transmission;
in a case that the sub-band is configured into the uplink resource by the semi-static signaling, and the format index in the dynamic signaling indicates F, the terminal determines the transmission direction of the sub-band to be F for uplink data and downlink data transmission, and the outside sub-band is used for downlink data transmission;
in a case that the sub-band is configured into the uplink resource by the semi-static signaling, and the format index in the dynamic signaling indicates F, the terminal determines the transmission direction of the sub-band to be downlink for downlink data transmission, and the outside sub-band is used for downlink data transmission;
in a case that the sub-band is configured into the uplink resource by the semi-static signaling, and the format index in the dynamic signaling indicates D, the terminal determines the transmission direction of the sub-band to be downlink for downlink data transmission, and the outside sub-band is used for downlink data transmission;
in a case that the sub-band is configured into the flexible resource by the semi-static signaling, and the format index in the dynamic signaling indicates F, the terminal determines the transmission direction of the sub-band to be F for uplink data and downlink data transmission, and the outside sub-band is used for downlink data transmission;
in a case that the sub-band is configured into the flexible resource by the semi-static signaling, and the format index in the dynamic signaling indicates D, the terminal determines the transmission direction of the sub-band to be downlink for downlink data transmission, and the outside sub-band is used for downlink data transmission;
in a case that the sub-band is configured into the flexible resource by the semi-static signaling, and the format index in the dynamic signaling indicates U, the terminal determines the transmission direction of the sub-band to be uplink for uplink data transmission, and the outside sub-band is used for downlink data transmission;
in a case that the sub-band is configured into the downlink resource by the semi-static signaling, and the format index in the dynamic signaling indicates D, the terminal determines the transmission direction of the sub-band to be downlink for downlink data transmission;
in a case that the sub-band is configured into the downlink resource by the semi-static signaling, and the format index in the dynamic signaling indicates F, the terminal determines the transmission direction of the sub-band to be downlink for downlink data transmission; and
in a case that the sub-band is configured into the downlink resource by the semi-static signaling, and the format index in the dynamic signaling indicates U, the terminal determines the transmission direction of the sub-band to be downlink for downlink data transmission.

In another specific example, the dynamic signaling is DCI format 2_0, the SBFD pattern is configured by the semi-static signaling on the flexible symbol F, and that the terminal receives the DCI format 2_0 and determines the transmission direction according to the format index in the dynamic signaling includes any one of the following: the indication direction of the DCI format 2_0 is used or not used on the downlink sub-band in the symbol F, the indication direction of the DCI format 2_0 is used or not used on the uplink sub-band in the symbol F, and the indication direction of the DCI format 2_0 is used or not used on the flexible sub-band in the symbol F.

Specifically, as shown in Table 2:

TABLE 2

| Configuration | Indication | Sub-band transmission direction |
|---|---|---|
| direction of | direction of | determined by UE after receiving |
| Semistatic-subband | format index | format index |
| U | D | D |
| U | F | F |
| U | D | U |
| U | U | U |
| U | F | U |
| D | U | U |
| D | F | F |
| D | U | D |
| D | D | D |
| D | F | D |
| F | D | D |
| F | U | U |
| F | F | F |
| F | D | F |
| F | U | F |

It can be seen that in the flexible symbols, any one of the following conditions is included:
in a case that the sub-band is configured into the uplink resource by the semi-static signaling, and the format index in the dynamic signaling indicates D, the terminal determines the transmission direction of the sub-band to be downlink for downlink data transmission;
in a case that the sub-band is configured into the uplink resource by the semi-static signaling, and the format index in the dynamic signaling indicates F, the terminal determines the transmission direction of the sub-band to be F for downlink data and uplink data transmission;
in a case that the sub-band is configured into the uplink resource by the semi-static signaling, and the format index in the dynamic signaling indicates D, the terminal determines the transmission direction of the sub-band to be uplink for uplink data transmission;
in a case that the sub-band is configured into the uplink resource by the semi-static signaling, and the format index in the dynamic signaling indicates U, the terminal determines the transmission direction of the sub-band to be uplink for uplink data transmission;
in a case that the sub-band is configured into the uplink resource by the semi-static signaling, and the format index in the dynamic signaling indicates F, the terminal determines the transmission direction of the sub-band to be uplink for uplink data transmission;
in a case that the sub-band is configured into the downlink resource by the semi-static signaling, and the format index in the dynamic signaling indicates U, the terminal determines the transmission direction of the sub-band to be uplink for uplink data transmission;
in a case that the sub-band is configured into the downlink resource by the semi-static signaling, and the format index in the dynamic signaling indicates F, the terminal determines the transmission direction of the sub-band to be F for downlink data and uplink data transmission;
in a case that the sub-band is configured into the downlink resource by the semi-static signaling, and the format index in the dynamic signaling indicates U, the terminal determines the transmission direction of the sub-band to be downlink for downlink data transmission;
in a case that the sub-band is configured into the downlink resource by the semi-static signaling, and the format index in the dynamic signaling indicates D, the terminal determines the transmission direction of the sub-band to be downlink for downlink data transmission;
in a case that the sub-band is configured into the downlink resource by the semi-static signaling, and the format index in the dynamic signaling indicates F, the terminal determines the transmission direction of the sub-band to be downlink for downlink data transmission;
in a case that the sub-band is configured into the flexible resource by the semi-static signaling, and the format index in the dynamic signaling indicates D, the terminal determines the transmission direction of the sub-band to be downlink for downlink data transmission;
in a case that the sub-band is configured into the flexible resource by the semi-static signaling, and the format index in the dynamic signaling indicates U, the terminal determines the transmission direction of the sub-band to be uplink for uplink data transmission;
in a case that the sub-band is configured into the flexible resource by the semi-static signaling, and the format index in the dynamic signaling indicates F, the terminal determines the transmission direction of the sub-band to be F for downlink data and uplink data transmission;
in a case that the sub-band is configured into the flexible resource by the semi-static signaling, and the format index in the dynamic signaling indicates D, the terminal determines the transmission direction of the sub-band to be F for downlink data and uplink data transmission; and
in a case that the sub-band is configured into the flexible resource by the semi-static signaling, and the format index in the dynamic signaling indicates U, the terminal determines the transmission direction of the sub-band to be F for downlink data and uplink data transmission.

In further another specific example, the dynamic signaling is DCI format 2_0, the SBFD pattern is configured by the semi-static signaling on the uplink symbol U, and that the terminal receives the DCI format 2_0 and determines the transmission direction according to the format index in the dynamic signaling includes any one of the following: the indication direction of the DCI format 2_0 is used on the downlink sub-band in the uplink symbol, the indication direction of the DCI format 2_0 is not used on the uplink sub-band in the uplink symbol, and the indication direction of the DCI format 2_0 is not used on the flexible sub-band in the uplink symbol.

Specifically, as shown in Table 3:

TABLE 3

| | | | Transmission |
|---|---|---|---|
| | | | direction |
| | | | outside the |
| | | | sub-band, i.e., |
| | | Sub-band | transmission |
| | | transmission | direction of |
| | | direction | outside sub-band |
| Configuration | | determined | (Outside subband), |
| direction of | Indication | by UE after | determined by UE |
| semi-static sub-band | direction of | receiving | after receiving |
| (Semistatic-subband) | format index | format index | format index |
| D | U | D | U |
| D | F | D | U |
| D | F | F | U |
| D | F | U | U |
| D | D | D | U |
| F | F | F | U |
| F | D | D | U |
| F | U | U | U |
| U | D | U | NA |
| U | F | U | NA |
| U | U | U | NA |

It can be seen that in the uplink symbols, any one of the following conditions is included:
in a case that the sub-band is configured into the downlink resource by the semi-static signaling, and the format index in the dynamic signaling indicates U, the terminal determines the transmission direction of the sub-band to be downlink for downlink data transmission, and the outside sub-band is used for uplink data transmission;
in a case that the sub-band is configured into the downlink resource by the semi-static signaling, and the format index in the dynamic signaling indicates F, the terminal determines the transmission direction of the sub-band to be downlink for downlink data transmission, and the outside sub-band is used for uplink data transmission;
in a case that the sub-band is configured into the downlink resource by the semi-static signaling, and the format index in the dynamic signaling indicates F, the terminal determines the transmission direction of the sub-band to be F for downlink data and uplink data transmission, and the outside sub-band is used for uplink data transmission;
in a case that the sub-band is configured into the downlink resource by the semi-static signaling, and the format index in the dynamic signaling indicates F, the terminal determines the transmission direction of the sub-band to be uplink for uplink data transmission, and the outside sub-band is used for uplink data transmission;
in a case that the sub-band is configured into the downlink resource by the semi-static signaling, and the format index in the dynamic signaling indicates D, the terminal determines the transmission direction of the sub-band to be downlink for downlink data transmission, and the outside sub-band is used for uplink data transmission;
in a case that the sub-band is configured into the flexible resource by the semi-static signaling, and the format index in the dynamic signaling indicates F, the terminal determines the transmission direction of the sub-band to be F for uplink data and downlink data transmission, and the outside sub-band is used for uplink data transmission;
in a case that the sub-band is configured into the flexible resource by the semi-static signaling, and the format index in the dynamic signaling indicates D, the terminal determines the transmission direction of the sub-band to be downlink for downlink data transmission, and the outside sub-band is used for uplink data transmission;
in a case that the sub-band is configured into the flexible resource by the semi-static signaling, and the format index in the dynamic signaling indicates U, the terminal determines the transmission direction of the sub-band to be uplink for uplink data transmission, and the outside sub-band is used for uplink data transmission;
in a case that the sub-band is configured into the uplink resource by the semi-static signaling, and the format index in the dynamic signaling indicates D, the terminal determines the transmission direction of the sub-band to be uplink for uplink data transmission;
in a case that the sub-band is configured into the uplink resource by the semi-static signaling, and the format index in the dynamic signaling indicates F, the terminal determines the transmission direction of the sub-band to be uplink for uplink data transmission; and
in a case that the sub-band is configured into the uplink resource by the semi-static signaling, and the format index in the dynamic signaling indicates U, the terminal determines the transmission direction of the sub-band to be uplink for uplink data transmission.

It is worth noting that in the above examples, the direction F may be used for the guard sub-band. The downlink symbol, the flexible symbol and the uplink symbol are at least configured by the TDD-UL-DL-ConfigurationCommon and TDD-UL-DL-ConfigurationDedicated.

In some embodiments, the operation that the terminal determines whether the resource indicated by the SBFD pattern is available or not according to a transmission direction of the first time-domain unit scheduled or configured by the dynamic signaling includes at least one of the following:
in a case that uplink transmission is scheduled or configured by the dynamic signaling on an uplink sub-band indicated by the SBFD pattern, determining that the uplink sub-band indicated by the SBFD pattern is available;
in a case that downlink transmission is scheduled or configured by the dynamic signaling on the uplink sub-band indicated by the SBFD pattern, determining that the uplink sub-band indicated by the SBFD pattern is unavailable;
in a case that uplink transmission is scheduled or configured by the dynamic signaling on a downlink sub-band indicated by the SBFD pattern, determining that the downlink sub-band indicated by the SBFD pattern is unavailable; and
in a case that downlink transmission is scheduled or configured by the dynamic signaling on the downlink sub-band indicated by the SBFD pattern, determining that the downlink sub-band indicated by the SBFD pattern is available.

In a specific example, as shown in FIG. 9, the potential SBFD pattern configured by the semi-static signaling exists on slots 1, 2, 3, 6, 7, and 8, and the dynamic signaling is the UE dedicated DCI format, for example, DCI format 0_0, 0_1, 0_2, 1_0, 1_1, 1_2, and the like. In a case that the UE receives DCI format 0_0, or 0_1, or 0_2, or 1_0, or 1_1, or 1_2, uplink transmission, such as the physical random access channel (PRACH), the physical uplink shared channel (PUSCH), the sounding reference signal (SRS) or the physical uplink control channel (PUCCH) are scheduled on the slot 3, the potential SBFD pattern of the slot 3 takes effect, and the uplink sub-band is available. In a case that the UE receives DCI format 1_0, or 1_1, or 1_2, the downlink transmission, such as the physical downlink shared channel (PDSCH), the phase tracking reference signal (TRS) or the channel state information-reference signal (CSI-RS) is scheduled on the slot 1, the potential SBFD pattern of the slot1 does not take effect, and the uplink sub-band is unavailable.

In some embodiments, the terminal is not expected to receive a first dynamic signaling and a second dynamic signaling, and for a same first time-domain unit, the first dynamic signaling indicates that the SBFD pattern configured for the first time-domain unit takes effect, and the second dynamic signaling indicates that the SBFD pattern configured for the first time-domain unit does not take effect. Therefore, the reception of contradictory instructions by the terminal may be avoided, and the terminal behavior may be clear.

In a specific example, as shown in FIG. 12, the dynamic signaling 1 indicates that the potential SBFD pattern on slots 3 and 8 takes effect, the potential SBFD pattern on slots 1, 2, 6, and 7 does not take effect, and these slots are still used as downlink slots; and the dynamic signaling 2 indicates that the potential SBFD pattern on slots 7 and 8 takes effect, the potential SBFD pattern on slot 6 does not take effect, and the slot 7 may have an error in case that this slot is still used as the downlink slot.

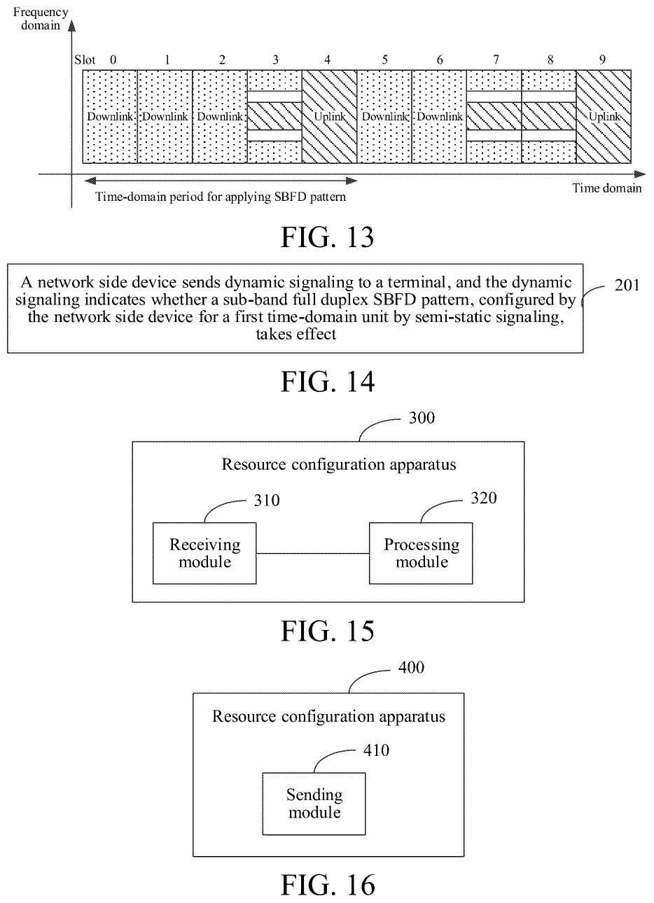

As shown in FIG. 13, the dynamic signaling 1 indicates that the potential SBFD pattern on slots 3, 7, and 8 takes effect, the potential SBFD pattern on slots 1, 2, and 6 does not take effect, and these slots are still used as downlink slots; and the dynamic signaling 2 indicates that the potential SBFD pattern on slots 7 and 8 takes effect, the potential SBFD pattern on slot 6 does not take effect, and the slot 7 may not have an error in case that this slot is still used as the downlink slot.

In some embodiments, the method further includes:
the terminal receives first indication information sent by the network side device, and the first indication information indicates reception of the dynamic signaling at a first time location.

The operation that the terminal determines available resources for the first time-domain unit according to the dynamic signaling and the SBFD pattern includes:
in a case that the dynamic signaling is not received at the first time location, the terminal determines that the resource indicated by the SBFD pattern is available; or
the terminal determines that the resource indicated by the SBFD pattern is unavailable;
or
the terminal determines whether the resource indicated by the SBFD pattern is available or not according to the dynamic signaling received at the last time; or
the terminal determines that the resource indicated by the SBFD pattern is available or unavailable according to the configuration of the network side device.

In a case that the terminal does not receive the dynamic signaling, it may be because the network side device does not send the dynamic signaling, the network side device has data or signals with higher priority to transmit, and the flexibility is provided for the network side device to determine whether to send the dynamic signaling or not. The other condition is that the network side device sends the dynamic signaling, but the terminal side does not detect the dynamic signaling. Regardless of the reasons causing a result that the terminal does not receive the dynamic signaling, this embodiment makes the terminal behavior clear.

Embodiments of this application provide a resource configuration method. As shown in FIG. 14, the method includes:

Step 201: A network side device sends a dynamic signaling to a terminal, and the dynamic signaling indicates whether a sub-band full duplex SBFD pattern, configured by the network side device for a first time-domain unit by a semi-static signaling, takes effect or not.

In embodiments of this application, after the SBFD pattern is configured for the terminal by the semi-static signaling, the network side device indicates whether the SBFD pattern takes effect or not through the dynamic signaling. Therefore, the resource configuration may be dynamically adjusted according to the dynamic signaling, and the resource utilization rate may be improved.

In some embodiments, the method further includes:
the network side device sends SBFD configuration information to the terminal, and the SBFD configuration information includes at least one of the following:
a quantity of SBFD patterns;
a time-domain period for applying SBFD pattern, where the time-domain period includes at least one first time-domain unit;
whether each of the first time-domain unit is configured with the SBFD pattern or not in the time-domain period for applying SBFD pattern;
the SBFD pattern configured for each of the first time-domain unit in the time-domain period for applying SBFD pattern; and
a quantity of the first time-domain unit included in the time-domain period for applying SBFD pattern.

In some embodiments, the SBFD pattern indicates at least one of the following of a serving cell or a carrier wave or a bandwidth part:
location information of an uplink frequency domain resource;
location information of a downlink frequency domain resource;
location information of a guard frequency domain resource; and
location information of a flexible frequency domain resource. The flexible frequency domain resource is used as at least one of the following:
a downlink frequency domain resource;
an uplink frequency domain resource;
an interference measurement resource; and
a guard frequency domain resource.

In some embodiments, in the time-domain period for applying SBFD pattern, the SBFD patterns configured for different first time-domain units are different or the same.

In some embodiments, a quantity X of slots or a quantity Y of symbols included by the first time-domain unit is configured by the network side device or defined by a protocol.

In some embodiments, the method further includes:
the network side device sends first indication information to the terminal, and the first indication information indicates reception of the dynamic signaling at a first time location.

In some embodiments, the operation that the network side device sends a dynamic signaling to the terminal includes:
the network side device sends a first dynamic signaling and a second dynamic signaling to the terminal, and the first dynamic signaling and the second dynamic signaling are not allowed to achieve the following effects: for a same first time-domain unit, the first dynamic signaling indicates that the SBFD pattern configured for the first time-domain unit takes effect, and the second dynamic signaling indicates that the SBFD pattern configured for the first time-domain unit does not take effect.

In some embodiments, the network side device sends the dynamic signaling to the terminal according to the uplink and downlink traffic volume and/or interference condition. For example, in a case that the uplink traffic volume is high, the network side device indicates that the uplink sub-band indicated by the SBFD pattern is available through the dynamic signaling. In a case that the downlink traffic volume is high, the network side device indicates that the downlink sub-band indicated by the SBFD pattern is available through the dynamic signaling. Therefore, the resource configuration may be dynamically adjusted according to the uplink traffic volume and the downlink traffic volume, the uplink and downlink traffic volume may be better matched, and the resource utilization rate may be improved.

Or, under the condition of serous interference of the downlink sub-band, the network side device indicates that the downlink sub-band indicated by the SBFD pattern is unavailable through the dynamic signaling, and under the condition of serous interference of the uplink sub-band, the network side device indicates that the uplink sub-band indicated by the SBFD pattern is unavailable through the dynamic signaling.

According to the resource configuration method provided by embodiments of this application, an execution body may be a resource configuration apparatus. The resource configuration apparatus provided by embodiments of this application is illustrated in embodiments of this application by taking the resource configuration apparatus implementing the resource configuration method as an example.

Embodiments of this application provide a resource configuration apparatus 300, applied to the terminal. As shown in FIG. 15, the apparatus includes:
a receiving module 310, configured to receive a dynamic signaling from a network side device, the dynamic signaling indicating whether a sub-band full duplex SBFD pattern, configured by the network side device for a first time-domain unit by a semi-static signaling, takes effect; and
a processing module 320, configured to determine available resources for the first time-domain unit according to the dynamic signaling and the SBFD pattern.

In embodiments of this application, after the SBFD pattern is configured for the terminal by the semi-static signaling, the network side device indicates whether the SBFD pattern takes effect or not through the dynamic signaling. Therefore, the resource configuration may be dynamically adjusted according to the dynamic signaling, and the resource utilization rate may be improved.

In some embodiments, the receiving module 310 is also configured to receive SBFD configuration information indicated by the semi-static signaling, and the SBFD configuration information includes at least one of the following:
a quantity of SBFD patterns;
a time-domain period for applying SBFD pattern, where the time-domain period includes at least one first time-domain unit;
whether each of the first time-domain unit is configured with the SBFD pattern or not in the time-domain period for applying SBFD pattern;
the SBFD pattern configured for each of the first time-domain unit in the time-domain period for applying SBFD pattern; and
a quantity of the first time-domain unit included in the time-domain period for applying SBFD pattern.

In some embodiments, the SBFD pattern indicates at least one of the following of a serving cell or a carrier wave or a bandwidth part:
location information of an uplink frequency domain resource;
location information of a downlink frequency domain resource;
location information of a guard frequency domain resource; and
location information of a flexible frequency domain resource. The flexible frequency domain resource is used as at least one of the following:
a downlink frequency domain resource;
an uplink frequency domain resource;
an interference measurement resource; and
a guard frequency domain resource.

In some embodiments, in the time-domain period for applying SBFD pattern, the SBFD patterns configured for different first time-domain units are different or the same.

In some embodiments, a quantity X of slots or a quantity Y of symbols included by the first time-domain unit is configured by the network side device or defined by a protocol.

In some embodiments, in a case that the first time-domain unit is configured with multiple SBFD patterns, the SBFD pattern available for use by the terminal in the first time-domain unit is determined by at least one of the following:
configuration information of a previous first time-domain unit adjacent to the first time-domain unit;
configuration information of a subsequent first time-domain unit adjacent to the first time-domain unit;
whether the first time-domain unit includes a flexible symbol configured by the semi-static signaling or not; and
whether the first time-domain unit is configured to include an uplink and downlink conversion symbol or not, where
the configuration information includes at least one of the following: the configured SBFD pattern, whether to be configured into a downlink resource by the semi-static signaling or not, whether to be configured into an uplink resource by the semi-static signaling or not, and whether to be configured into a flexible resource by the semi-static signaling or not.

In some embodiments, the semi-static signaling is system information or a cell common signaling, a subcarrier space SCS used by the SBFD pattern is equal to or greater than a first SCS, the first SCS is an SCS configured by a time division duplex uplink downlink common configuration signaling TDD-UL-DL-ConfigCommon.

In some embodiments, the semi-static signaling is a radio resource control RRC message, and the SCS used by the SBFD pattern is the same as an SCS of an initial downlink or uplink bandwidth part of the serving cell configured with the SBFD pattern; or
the SCS used by the SBFD pattern is the same as an SCS of an active downlink or uplink bandwidth part configured with the SBFD pattern; or
the SCS used by the SBFD pattern is configured by the network side device.

In some embodiments, the available resources for the first time-domain unit include at least one of the following:
a downlink sub-band indicated by the SBFD pattern;
an uplink sub-band indicated by the SBFD pattern;
a flexible sub-band indicated by the SBFD pattern; and
a guard sub-band indicated by the SBFD pattern.

In some embodiments, the processing module 320 is specifically used for executing any one of the following:
in a case that the dynamic signaling is in a downlink control information DCI format 2_0, determining whether the resource indicated by the SBFD pattern is available or not according to a transmission direction of the first time-domain unit configured by the semi-static signaling and indication of a format index in the dynamic signaling; and
in a case that the dynamic signaling is terminal dedicated DCI and/or an RRC message, determining whether the resource indicated by the SBFD pattern is available or not according to a transmission direction of the first time-domain unit scheduled or configured by the dynamic signaling.

In some embodiments, the processing module 320 is specifically used for executing at least one of the following:
in a case that the first time-domain unit is configured into a downlink resource by the semi-static signaling, and the format index in the dynamic signaling indicates uplink, determining that an uplink sub-band indicated by the SBFD pattern is available;
in a case that the first time-domain unit is configured into the downlink resource by the semi-static signaling, and the format index in the dynamic signaling indicates downlink, determining that the uplink sub-band indicated by the SBFD pattern is unavailable;
in a case that the first time-domain unit is configured into the downlink resource by the semi-static signaling, and the format index in the dynamic signaling indicates a flexible resource F or a first value, determining that the uplink sub-band indicated by the SBFD pattern is unavailable;
in a case that the first time-domain unit is configured into the downlink resource by the semi-static signaling, and the format index in the dynamic signaling indicates the flexible resource F or the first value, determining that the uplink sub-band indicated by the SBFD pattern is available;
in a case that the first time-domain unit is configured into an uplink resource by the semi-static signaling, and the format index in the dynamic signaling indicates downlink, determining that a downlink sub-band indicated by the SBFD pattern is available;
in a case that the first time-domain unit is configured into the uplink resource by the semi-static signaling, and the format index in the dynamic signaling indicates uplink, determining that the downlink sub-band indicated by the SBFD pattern is unavailable;
in a case that the first time-domain unit is configured into the uplink resource by the semi-static signaling, and the format index in the dynamic signaling indicates the flexible resource F or the first value, determining that the downlink sub-band indicated by the SBFD pattern is unavailable;
in a case that the first time-domain unit is configured into the uplink resource by the semi-static signaling, and the format index in the dynamic signaling indicates the flexible resource F or the first value, determining that the uplink sub-band indicated by the SBFD pattern is available;
in a case that the first time-domain unit is configured into a flexible resource by the semi-static signaling, and the format index in the dynamic signaling indicates downlink, determining that the downlink sub-band indicated by the SBFD pattern is available;
in a case that the first time-domain unit is configured into the flexible resource by the semi-static signaling, and the format index in the dynamic signaling indicates downlink, determining that the downlink sub-band indicated by the SBFD pattern is unavailable;
in a case that the first time-domain unit is configured into the flexible resource by the semi-static signaling, and the format index in the dynamic signaling indicates downlink, determining that the resource indicated by the SBFD pattern is unavailable, and the downlink resource configured by the TDD-UL-DL-ConfigCommon and/or a time division duplex uplink downlink dedicated configuration signaling TDD-UL-DL-ConfigDedicated is available;
in a case that the first time-domain unit is configured into the flexible resource by the semi-static signaling, and the format index in the dynamic signaling indicates uplink, determining that the uplink sub-band indicated by the SBFD pattern is available;
in a case that the first time-domain unit is configured into the flexible resource by the semi-static signaling, and the format index in the dynamic signaling indicates uplink, determining that the uplink sub-band indicated by the SBFD pattern is unavailable;
in a case that the first time-domain unit is configured into the flexible resource by the semi-static signaling, and the format index in the dynamic signaling indicates uplink, determining that the resource indicated by the SBFD pattern is unavailable, and the uplink resource configured by the TDD-UL-DL-ConfigCommon and/or TDD-UL-DL-ConfigDedicated is available;
in a case that the first time-domain unit is configured into the flexible resource by the semi-static signaling, and the format index in the dynamic signaling indicates the flexible resource F or the first value, determining that the uplink sub-band indicated by the SBFD pattern is available;
in a case that the first time-domain unit is configured into the flexible resource by the semi-static signaling, and the format index in the dynamic signaling indicates the flexible resource F or the first value, determining that the uplink sub-band indicated by the SBFD pattern is unavailable;
in a case that the first time-domain unit is configured into the flexible resource by the semi-static signaling, and the format index in the dynamic signaling indicates the flexible resource F or the first value, determining that the downlink sub-band indicated by the SBFD pattern is available;
in a case that the first time-domain unit is configured into the flexible resource by the semi-static signaling, and the format index in the dynamic signaling indicates the flexible resource F or the first value, determining that the downlink sub-band indicated by the SBFD pattern is unavailable;
in a case that the first time-domain unit is configured into the flexible resource by the semi-static signaling, and the format index in the dynamic signaling indicates the flexible resource F or the first value, determining that the resource indicated by the SBFD pattern is available; and
in a case that the first time-domain unit is configured into the flexible resource by the semi-static signaling, and the format index in the dynamic signaling indicates the flexible resource F or the first value, determining that the resource indicated by the SBFD pattern is unavailable, and the flexible resource configured by the TDD-UL-DL-ConfigCommon and/or TDD-UL-DL-ConfigDedicated is available.

In some embodiments, the processing module 320 is specifically used for executing at least one of the following:
in a case that uplink transmission is scheduled or configured by the dynamic signaling on an uplink sub-band indicated by the SBFD pattern, determining that the uplink sub-band indicated by the SBFD pattern is available;
in a case that downlink transmission is scheduled or configured by the dynamic signaling on the uplink sub-band indicated by the SBFD pattern, determining that the uplink sub-band indicated by the SBFD pattern is unavailable;
in a case that uplink transmission is scheduled or configured by the dynamic signaling on a downlink sub-band indicated by the SBFD pattern, determining that the downlink sub-band indicated by the SBFD pattern is unavailable; and
in a case that downlink transmission is scheduled or configured by the dynamic signaling on the downlink sub-band indicated by the SBFD pattern, determining that the downlink sub-band indicated by the SBFD pattern is available.

In some embodiments, the receiving module 310 is used for being not expected to receive first dynamic signaling and second dynamic signaling, and for a same first time-domain unit, the first dynamic signaling indicates that the SBFD pattern configured for the first time-domain unit takes effect, and the second dynamic signaling indicates that the SBFD pattern configured for the first time-domain unit does not take effect.

In some embodiments, the receiving module 310 is used for receiving first indication information sent by the network side device, and the first indication information indicates reception of the dynamic signaling at a first time location.

The processing module 320 is used for determining that the resource indicated by the SBFD pattern is available in a case that the dynamic signaling is not received at the first time location; or
determining that the resource indicated by the SBFD pattern is unavailable; or
determining, by the terminal, whether the resource indicated by the SBFD pattern is available or not according to the dynamic signaling received at the last time;
or
determining that the resource indicated by the SBFD pattern is available or unavailable according to the configuration of the network side device.

Embodiments of this application provide a resource configuration apparatus 400, applied to the network side device. As shown in FIG. 16, the apparatus includes:
a sending module 410, configured to send a dynamic signaling to a terminal. The dynamic signaling indicates whether a sub-band full duplex SBFD pattern, configured by the network side device for a first time-domain unit by a semi-static signaling, takes effect or not.

In embodiments of this application, after the SBFD pattern is configured for the terminal by the semi-static signaling, the network side device indicates whether the SBFD pattern takes effect or not through the dynamic signaling. Therefore, the resource configuration may be dynamically adjusted according to the dynamic signaling, and the resource utilization rate may be improved.

In some embodiments, the sending module 410 is also used for sending SBFD configuration information indicated by the semi-static signaling to the terminal, and the SBFD configuration information includes at least one of the following:
a quantity of SBFD patterns;
a time-domain period for applying SBFD pattern, where the time-domain period includes at least one first time-domain unit;
whether each of the first time-domain unit is configured with the SBFD pattern or not in the time-domain period for applying SBFD pattern;
the SBFD pattern configured for each of the first time-domain unit in the time-domain period for applying SBFD pattern; and
a quantity of the first time-domain unit included in the time-domain period for applying SBFD pattern.

In some embodiments, the SBFD pattern indicates at least one of the following of a serving cell or a carrier wave or a bandwidth part:
location information of an uplink frequency domain resource;
location information of a downlink frequency domain resource;
location information of a guard frequency domain resource; and
location information of a flexible frequency domain resource. The flexible frequency domain resource is used as at least one of the following:
a downlink frequency domain resource;
an uplink frequency domain resource;
an interference measurement resource; and
a guard frequency domain resource.

In some embodiments, in the time-domain period for applying SBFD pattern, the SBFD patterns configured for different first time-domain units are different or the same.

In some embodiments, a quantity X of slots or a quantity Y of symbols included by the first time-domain unit is configured by the network side device or defined by a protocol.

In some embodiments, the sending module 410 is further used for sending first indication information to the terminal, and the first indication information indicates reception of the dynamic signaling at a first time location.

In some embodiments, the sending module 410 is used for sending a first dynamic signaling and a second dynamic signaling to the terminal, and the first dynamic signaling and the second dynamic signaling are not allowed to achieve the following effects: for a same first time-domain unit, the first dynamic signaling indicates that the SBFD pattern configured for the first time-domain unit takes effect, and the second dynamic signaling indicates that the SBFD pattern configured for the first time-domain unit does not take effect.

The resource configuration apparatus in embodiments of this application may be an electronic device, for example, an electronic device with an operating system, or may be a component in an electronic device, for example, an integrated circuit or a chip. The electronic device may be a terminal, or may be another device other than a terminal. Exemplarily, the terminal may include, but is not limited to types of the terminal 11 listed above. Another device may be a server, a network attached storage (Network Attached Storage, NAS), and the like. This is not specifically limited in embodiments of this application.

Through the resource configuration apparatus provided by embodiments of this application, each process implemented by the method embodiments shown in FIG. 6 to FIG. 14 may be performed, and the same technical effects may be achieved. To avoid repetition, details are not described herein again.

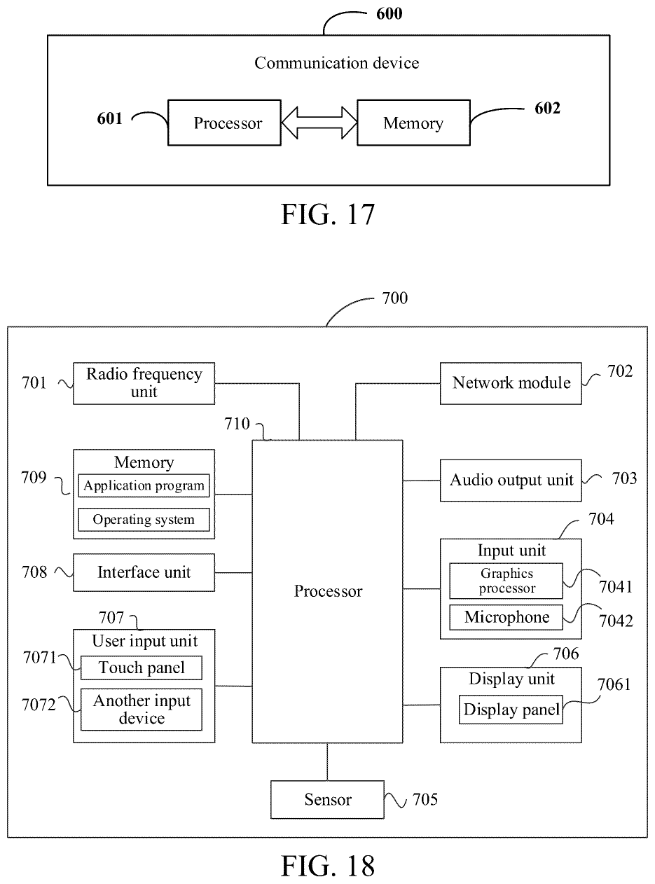

Optionally, as shown in FIG. 17, embodiments of this application further provide a communication device 600, including a processor 601 and a memory 602. The memory 602 stores a program or instruction runnable on the processor 601. For example, in a case that the communication device 600 is a network side device, when executed by the processor 601, the program or the instruction implements each step of the resource configuration method embodiments, and the same technical effect may be achieved. In a case that the communication device 600 is a terminal, when executed by the processor 601, the program or the instruction implements each step of the resource configuration method embodiments, and the same technical effect may be achieved. To avoid repetition, details are not described herein again.

Embodiments of this application further provide a network side device. The network side device includes a processor and a memory. The memory stores a program or instruction runnable on the processor, and when executed by the processor, the program or instruction implements the steps of the resource configuration method.

Embodiments of this application further provide a network side device including a processor and a communication interface. The communication interface is configured to send a dynamic signaling to a terminal, and the dynamic signaling indicates whether a sub-band full duplex SBFD pattern, configured by the network side device for a first time-domain unit by a semi-static signaling, takes effect or not.

Embodiments of this application further provide a terminal including a processor and a memory, the memory stores a program or instruction runnable on the processor, and when executed by the processor, the program or instruction implements the steps of the resource configuration method.

Embodiments of this application further provide a terminal including a processor and a communication interface. The communication interface is configured to receive a dynamic signaling from a network side device, the dynamic signaling indicates whether a sub-band full duplex SBFD pattern, configured by the network side device for a first time-domain unit by a semi-static signaling, takes effect, and the processor is configured to determine available resources for the first time-domain unit according to the dynamic signaling and the SBFD pattern.

Embodiments of this application further provide a terminal including a processor and a communication interface. The terminal embodiment corresponds to the terminal side method embodiment. Each implementation process and each implementation of the method embodiments may be applied to the terminal embodiments and may achieve the same technical effect. Specifically, FIG. 18 is a schematic diagram of a hardware structure of a terminal according to embodiments of this application.

The terminal 700 includes but is not limited to at least some components of a radio frequency unit 701, a network module 702, an audio output unit 703, an input unit 704, a sensor 705, a display unit 706, a user input unit 707, an interface unit 708, a memory 709, a processor 710, and the like.

A person skilled in the art may understand that the terminal 700 may further include a power supply (for example, a battery) for supplying electricity to each component. The power supply may be logically connected to the processor 710 by a power management system to implement functions such as charging and discharging management, and power consumption management through the power management system. The structure of the terminal shown in FIG. 18 does not constitute any limitation to the terminal, and the terminal may include more or fewer components than a structure shown in the figures, or may combine some components, or have different component arrangements. Details are not described herein again.

It should be understood that in embodiments of this application, the input unit 704 may include a graphics processing unit (Graphics Processing Unit, GPU) 7041 and a microphone 7042. The GPU7041 processes image data of a still picture or video acquired by an image capture apparatus (for example, a camera) in a video capture mode or an image capture mode. The display unit 706 may include a display panel 7061. The display panel 7061 may be configured by using a liquid crystal display, an organic light-emitting diode, and the like. The user input unit 707 includes at least one of a touch panel 7071 and another input device 7072. The touch panel 7071 is also referred to as a touchscreen. The touch panel 7071 may include two parts: a touch detection apparatus and a touch controller. Another input device 7072 may include, but is not limited to a physical keyboard, a functional key (such as a volume control key or a switch key), a track ball, a mouse, and a joystick. Details are not described herein again.

In embodiments of this application, the ratio frequency unit 701 may transmit the downlink data to the processor 710 to be processed after receiving the downlink data from the network side device. Additionally, the radio frequency unit 701 may send the uplink data to the network side device. Generally, the radio frequency unit 701 includes, but is not limited to an antenna, an amplifier, a transceiver, a coupler, a low-noise amplifier, a duplexer, and the like.

The memory 709 may be configured to store a software program or an instruction and various data. The memory 709 may mainly include a first storage area for storing the program or the instruction and a second storage area for storing data. The first storage area may store the operating system, an application or instruction (for example, a sound playback function, an image playback function) required for at least one function, and the like. Moreover, the memory 709 may include a volatile memory or a non-volatile memory, or may the memory 709 may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct Rambus random access memory (Direct Rambus RAM, DRRAM). The memory 709 in embodiments of this application includes, but is not limited to these memories and any other memories of suitable types.

The processor 710 may include one or more processing units. Optionally, the processor 710 may integrate an application processor and a modem processor. The application processor mainly processes operations about an operating system, a user interface, an application program, and the like. The modem processor mainly processes a wireless communication signal, and is, for example, a baseband processor. It may be understood that the modem processor may not be integrated into the processor 710.

In some embodiments, the processor 710 is used for receiving the dynamic signaling of the network side device. The dynamic signaling indicates whether a sub-band full duplex SBFD pattern configured by the network side device for a first time-domain unit by semi-static signaling takes effect or not, and available resources for the first time-domain unit are determined according to the dynamic signaling and the SBFD pattern.

In some embodiments, the processor 710 is also configured to receive SBFD configuration information indicated by the semi-static signaling, and the SBFD configuration information includes at least one of the following:
a quantity of SBFD patterns;
a time-domain period for applying SBFD pattern, where the time-domain period includes at least one first time-domain unit;
whether each of the first time-domain unit is configured with the SBFD pattern or not in the time-domain period for applying SBFD pattern;
the SBFD pattern configured for each of the first time-domain unit in the time-domain period for applying SBFD pattern; and
a quantity of the first time-domain unit included in the time-domain period for applying SBFD pattern.

In some embodiments, the SBFD pattern indicates at least one of the following of a serving cell or a carrier wave or a bandwidth part:
location information of an uplink frequency domain resource;
location information of a downlink frequency domain resource;
location information of a guard frequency domain resource; and
location information of a flexible frequency domain resource. The flexible frequency domain resource is used as at least one of the following:
a downlink frequency domain resource;
an uplink frequency domain resource;
an interference measurement resource; and
a guard frequency domain resource.

In some embodiments, in the time-domain period for applying SBFD pattern, the SBFD patterns configured for different first time-domain units are different or the same.

In some embodiments, a quantity X of slots or a quantity Y of symbols included by the first time-domain unit is configured by the network side device or defined by a protocol.

In some embodiments, in a case that the first time-domain unit is configured with multiple SBFD patterns, the SBFD pattern available for use by the terminal in the first time-domain unit is determined by at least one of the following:
configuration information of a previous first time-domain unit adjacent to the first time-domain unit;
configuration information of a subsequent first time-domain unit adjacent to the first time-domain unit;
whether the first time-domain unit includes a flexible symbol configured by the semi-static signaling or not; and
whether the first time-domain unit is configured to include an uplink and downlink conversion symbol or not, where
the configuration information includes at least one of the following: the configured SBFD pattern, whether to be configured into a downlink resource by the semi-static signaling or not, whether to be configured into an uplink resource by the semi-static signaling or not, and whether to be configured into a flexible resource by the semi-static signaling or not.

In some embodiments, the semi-static signaling is system information or cell common signaling, a subcarrier space SCS used by the SBFD pattern is equal to or greater than a first SCS, the first SCS is an SCS configured by a time division duplex uplink downlink common configuration signaling TDD-UL-DL-ConfigCommon.

In some embodiments, the semi-static signaling is a radio resource control RRC message, and the SCS used by the SBFD pattern is the same as an SCS of an initial downlink or uplink bandwidth part of the serving cell configured with the SBFD pattern; or
the SCS used by the SBFD pattern is the same as an SCS of an active downlink or uplink bandwidth part configured with the SBFD pattern; or the SCS used by the SBFD pattern is configured by the network side device.

In some embodiments, the available resources for the first time-domain unit include at least one of the following:
a downlink sub-band indicated by the SBFD pattern;
an uplink sub-band indicated by the SBFD pattern;
a flexible sub-band indicated by the SBFD pattern; and
a guard sub-band indicated by the SBFD pattern.

In some embodiments, the processor 710 is used for executing any one of the following:
in a case that the dynamic signaling is in a downlink control information DCI format 2_0, determining whether the resource indicated by the SBFD pattern is available or not according to a transmission direction of the first time-domain unit configured by the semi-static signaling and indication of a format index in the dynamic signaling; and
in a case that the dynamic signaling is terminal dedicated DCI and/or an RRC message, determining whether the resource indicated by the SBFD pattern is available or not according to a transmission direction of the first time-domain unit scheduled or configured by the dynamic signaling.

In some embodiments, the processor 710 is specifically used for executing any one of the following:
in a case that the first time-domain unit is configured into a downlink resource by the semi-static signaling, and the format index in the dynamic signaling indicates uplink, determining that an uplink sub-band indicated by the SBFD pattern is available;
in a case that the first time-domain unit is configured into the downlink resource by the semi-static signaling, and the format index in the dynamic signaling indicates downlink, determining that the uplink sub-band indicated by the SBFD pattern is unavailable;
in a case that the first time-domain unit is configured into the downlink resource by the semi-static signaling, and the format index in the dynamic signaling indicates a flexible resource F or a first value, determining that the uplink sub-band indicated by the SBFD pattern is unavailable;
in a case that the first time-domain unit is configured into the downlink resource by the semi-static signaling, and the format index in the dynamic signaling indicates the flexible resource F or the first value, determining that the uplink sub-band indicated by the SBFD pattern is available;
in a case that the first time-domain unit is configured into an uplink resource by the semi-static signaling, and the format index in the dynamic signaling indicates downlink, determining that a downlink sub-band indicated by the SBFD pattern is available;
in a case that the first time-domain unit is configured into the uplink resource by the semi-static signaling, and the format index in the dynamic signaling indicates uplink, determining that the downlink sub-band indicated by the SBFD pattern is unavailable;
in a case that the first time-domain unit is configured into the uplink resource by the semi-static signaling, and the format index in the dynamic signaling indicates the flexible resource F or the first value, determining that the downlink sub-band indicated by the SBFD pattern is unavailable;
in a case that the first time-domain unit is configured into the uplink resource by the semi-static signaling, and the format index in the dynamic signaling indicates the flexible resource F or the first value, determining that the uplink sub-band indicated by the SBFD pattern is available;
in a case that the first time-domain unit is configured into a flexible resource by the semi-static signaling, and the format index in the dynamic signaling indicates downlink, determining that the downlink sub-band indicated by the SBFD pattern is available;
in a case that the first time-domain unit is configured into the flexible resource by the semi-static signaling, and the format index in the dynamic signaling indicates downlink, determining that the downlink sub-band indicated by the SBFD pattern is unavailable;
in a case that the first time-domain unit is configured into the flexible resource by the semi-static signaling, and the format index in the dynamic signaling indicates downlink, determining that the resource indicated by the SBFD pattern is unavailable, and the downlink resource configured by the TDD-UL-DL-ConfigCommon and/or a time division duplex uplink downlink dedicated configuration signaling TDD-UL-DL-ConfigDedicated is available;
in a case that the first time-domain unit is configured into the flexible resource by the semi-static signaling, and the format index in the dynamic signaling indicates uplink, determining that the uplink sub-band indicated by the SBFD pattern is available;
in a case that the first time-domain unit is configured into the flexible resource by the semi-static signaling, and the format index in the dynamic signaling indicates uplink, determining that the uplink sub-band indicated by the SBFD pattern is unavailable;
in a case that the first time-domain unit is configured into the flexible resource by the semi-static signaling, and the format index in the dynamic signaling indicates uplink, determining that the resource indicated by the SBFD pattern is unavailable, and the uplink resource configured by the TDD-UL-DL-ConfigCommon and/or TDD-UL-DL-ConfigDedicated is available;
in a case that the first time-domain unit is configured into the flexible resource by the semi-static signaling, and the format index in the dynamic signaling indicates the flexible resource F or the first value, determining that the uplink sub-band indicated by the SBFD pattern is available;
in a case that the first time-domain unit is configured into the flexible resource by the semi-static signaling, and the format index in the dynamic signaling indicates the flexible resource F or the first value, determining that the uplink sub-band indicated by the SBFD pattern is unavailable;
in a case that the first time-domain unit is configured into the flexible resource by the semi-static signaling, and the format index in the dynamic signaling indicates the flexible resource F or the first value, determining that the downlink sub-band indicated by the SBFD pattern is available;
in a case that the first time-domain unit is configured into the flexible resource by the semi-static signaling, and the format index in the dynamic signaling indicates the flexible resource F or the first value, determining that the downlink sub-band indicated by the SBFD pattern is unavailable;
in a case that the first time-domain unit is configured into the flexible resource by the semi-static signaling, and the format index in the dynamic signaling indicates the flexible resource F or the first value, determining that the resource indicated by the SBFD pattern is available; and
in a case that the first time-domain unit is configured into the flexible resource by the semi-static signaling, and the format index in the dynamic signaling indicates the flexible resource F or the first value, determining that the resource indicated by the SBFD pattern is unavailable, and the flexible resource configured by the TDD-UL-DL-ConfigCommon and/or TDD-UL-DL-ConfigDedicated is available.

In some embodiments, the processor 710 is specifically used for executing any one of the following:
in a case that uplink transmission is scheduled or configured by the dynamic signaling on an uplink sub-band indicated by the SBFD pattern, determining that the uplink sub-band indicated by the SBFD pattern is available;
in a case that downlink transmission is scheduled or configured by the dynamic signaling on the uplink sub-band indicated by the SBFD pattern, determining that the uplink sub-band indicated by the SBFD pattern is unavailable;
in a case that uplink transmission is scheduled or configured by the dynamic signaling on a downlink sub-band indicated by the SBFD pattern, determining that the downlink sub-band indicated by the SBFD pattern is unavailable; and
in a case that downlink transmission is scheduled or configured by the dynamic signaling on the downlink sub-band indicated by the SBFD pattern, determining that the downlink sub-band indicated by the SBFD pattern is available.

In some embodiments, the processor 710 is used for being not expected to receive a first dynamic signaling and a second dynamic signaling, and for a same first time-domain unit, the first dynamic signaling indicates that the SBFD pattern configured for the first time-domain unit takes effect, and the second dynamic signaling indicates that the SBFD pattern configured for the first time-domain unit does not take effect.

In some embodiments, the processor 710 is further used for receiving first indication information sent by the network side device, and the first indication information indicates reception of the dynamic signaling at a first time location.

The processor 710 is specifically used for determining that the resource indicated by the SBFD pattern is available in a case that the dynamic signaling is not received at the first time location; or
determining that the resource indicated by the SBFD pattern is unavailable; or
determining, by the terminal, whether the resource indicated by the SBFD pattern is available or not according to the dynamic signaling received at the last time;
or
determining that the resource indicated by the SBFD pattern is available or unavailable according to the configuration of the network side device.

Embodiments of this application further provide a network side device including a processor and a communication interface. The network side device embodiment corresponds to the network side device method embodiment. Each implementation process and each implementation of the method embodiments may be applied to the network side device embodiments and may achieve the same technical effect.

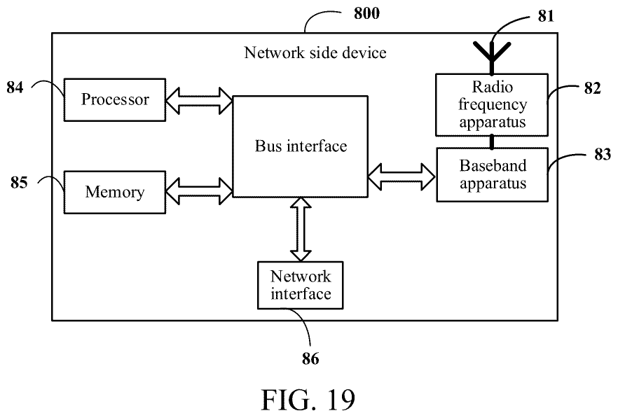

Specifically, embodiments of this application further provide a network side device. As shown in FIG. 19, the network side device 800 includes: an antenna 81, a radio frequency apparatus 82, a baseband apparatus 83, a processor 84 and a memory 85. The antenna 81 is connected to the radio frequency apparatus 82. In an uplink direction, the radio frequency apparatus 82 receives information from the antenna 81, and sends the received information to the baseband apparatus 83 to be processed. In a downlink direction, the baseband apparatus 83 processes information to be sent, and sends the information to the radio frequency apparatus 82, and the radio frequency apparatus 82 processes the received information and then sends the processed information through the antenna 81.

The method implemented by the network side device in the embodiments may be implemented in the baseband apparatus 83. The baseband apparatus 83 includes a baseband processor.

The baseband apparatus 83, for example, may include at least one baseband board. Multiple chips are disposed on the baseband board. As shown in FIG. 19, one chip, for example, a baseband processor, is connected to the memory 85 through a bus interface to call a program in the memory 85 for executing the network device operation shown in the method embodiments.

The network side device may further include a network interface 86. The interface, for example, is a common public radio interface (common public radio interface, CPRI).

Specifically, the network side device 800 according to embodiments of this application further include an instruction or program stored on the memory 85 and runnable on the processor 84. The processor 84 calls the instruction or program in the memory 85 to execute the resource configuration method, and the same technical effect may be achieved. To avoid repetition, details are not described herein again.

Embodiments of this application further provide a readable storage medium. The readable storage medium has a program or instruction stored thereon, where when executed by a processor, the program or instruction implements each process of the foregoing resource configuration method embodiments, and the same technical effects may be achieved. To avoid repetition, details are not described herein again.

The processor may be a processor in the terminal in above embodiments. The readable storage medium includes a computer-readable storage medium, such as a computer read-only memory ROM, a random access memory RAM, a magnetic disc, an optical disc, and the like.

Embodiments of this application further provide a chip. The chip includes a processor and a communication interface, the communication interface is coupled to the processor, and the processor is configured to run a program or instruction to implement each process of the above resource configuration method embodiments, and the same technical effects may be achieved. To avoid repetition, details are not described herein again.

It should be understood that the chip mentioned in embodiments of this application may also be referred to as a system on chip, a system chip, a chip system, a system-on-chip, and the like.

Embodiment of this application further provides a computer program/program product, the computer program/program product is stored in a storage medium, and the computer program/program product is executed by at least one processor to implement each process of the above resource configuration method embodiments, and the same technical effects may be achieved. To avoid repetition, details are not described herein again.

Embodiments of this application further provide a resource configuration system, including: a network side device and a terminal, the network side device may be configured to implement the steps of the resource configuration method, and the terminal may be configured to implement the steps of the resource configuration method.

It needs to be noted that terms “include”, “comprise”, or any other variation thereof herein are intended to cover a non-exclusive inclusion, so that a process, a method, an object, or an apparatus including a series of elements not only includes those elements but also includes other elements which are not clearly listed or further includes intrinsic elements of the process, the method, the object, or the apparatus. Without more limitations, an element defined by a sentence “including one” does not exclude a case that there are still other same elements in the process, the method, the object, or the apparatus including the element. In addition, it should be pointed out that the range of the method and apparatus in the implementation of this application is not limited to execution of functions in a shown or discussed order, and may further include execution of functions involved in a substantially simultaneous manner or in a reverse order. For example, the described method may be executed in an order different from the described order, and various steps may be added, omitted, or combined. Moreover, features described with the reference to some examples may be combined in other examples.

Through the above descriptions on the implementations, those skilled in the art may clearly know that each embodiment method may be realized with the help of software and a necessary universal hardware platform, and certainly may be realized through a hardware. But in many cases the former is a preferable implementation. Based on such understanding, the technical solutions of this application essentially, or a part contributing to the prior art, may be presented in a form of a computer software product. The computer software product is stored in a storage medium (for example, an ROM/RAM, a magnetic disk, or an optical disc) including several instructions to enable a terminal (which may be a mobile phone, a computer, a server, an air conditioner, a network device, and the like) to perform the methods described in the embodiments of this application.

The embodiments of this application are described above with the reference to the accompanying drawings, but this application is not limited to the above specific implementations. The above specific implementations are merely illustrative rather than restrictive. Inspired by this application, those of ordinary skill in the art may still make multiple forms without departing from the essence of this application and the protection scope of the claims, and these forms all fall within the protection of this application.

What is claimed is:

1. A resource configuration method, comprising:
receiving, by a terminal, sub-band full duplex (SBFD) configuration information indicated by a network side device, wherein the SBFD configuration information comprises at least one of the following:
a quantity of SBFD patterns;
a time-domain period for applying SBFD pattern, wherein the time-domain period comprises at least one first time-domain unit;
whether each of the first time-domain unit is configured with an SBFD pattern or not in the time-domain period for applying SBFD pattern;
the SBFD pattern configured for each of the first time-domain unit in the time-domain period for applying SBFD pattern; and
a quantity of the first time-domain unit comprised in the time-domain period for applying SBFD pattern.

2. The method according to claim 1, wherein the time-domain period for applying SBFD pattern is determined by downlink-uplink-transmission periodicity (DL-UL-TransmissionPeriodicity) that is configured by the network side device.

3. The method according to claim 2, wherein in a case that one SBFD pattern is configured, the time-domain period for applying the SBFD pattern is a period indicated by DL-UL-TransmissionPeriodicity corresponding to the one SBFD pattern; and
in a case that two SBFD patterns are configured, the time-domain period for applying the SBFD pattern is a sum of periods indicated by DL-UL-TransmissionPeriodicity respectively corresponding to the two SBFD patterns.

4. The method according to claim 1, further comprising:
receiving, by the terminal, a dynamic signaling from the network side device, wherein the dynamic signaling indicates whether an SBFD pattern, configured by the network side device for a first time-domain unit by a semi-static signaling, takes effect; and
determining, by the terminal, available resources for the first time-domain unit according to the dynamic signaling and the SBFD pattern.

5. The method according to claim 1, wherein in the time-domain period for applying SBFD pattern, SBFD patterns configured for different first time-domain units are different or the same; or
a quantity X of slots or a quantity Y of symbols comprised by the first time-domain unit is configured by the network side device or defined by a protocol.

6. The method according to claim 1, wherein in a case that the first time-domain unit is configured with a plurality of SBFD patterns, the SBFD pattern available for use by the terminal in the first time-domain unit is determined by at least one of the following:
configuration information of a previous first time-domain unit adjacent to the first time-domain unit;
configuration information of a subsequent first time-domain unit adjacent to the first time-domain unit;
whether the first time-domain unit comprises a flexible symbol configured by the semi-static signaling or not; and
whether the first time-domain unit is configured to comprise an uplink and downlink conversion symbol or not, wherein
the configuration information comprises at least one of the following: the configured SBFD pattern, whether to be configured into a downlink resource by the semi-static signaling or not, whether to be configured into an uplink resource by the semi-static signaling or not, and whether to be configured into a flexible resource by the semi-static signaling or not.

7. The method according to claim 4, wherein the semi-static signaling is system information or a cell common signaling, a subcarrier space SCS used by the SBFD pattern is equal to or greater than a first SCS, the first SCS is an SCS configured by a time division duplex uplink downlink common configuration signaling TDD-UL-DL-ConfigCommon;
or wherein the semi-static signaling is a radio resource control RRC message, and the SCS used by the SBFD pattern is the same as an SCS of an initial downlink or uplink bandwidth part of the serving cell configured with the SBFD pattern; or
the SCS used by the SBFD pattern is the same as an SCS of an active downlink or uplink bandwidth part configured with the SBFD pattern; or
the SCS used by the SBFD pattern is configured by the network side device.

8. The method according to claim 4, wherein the available resources for the first time-domain unit comprise at least one of the following:
a downlink sub-band indicated by the SBFD pattern;
an uplink sub-band indicated by the SBFD pattern;
a flexible sub-band indicated by the SBFD pattern; and
a guard sub-band indicated by the SBFD pattern.

9. The method according to claim 4, wherein the determining, by the terminal, available resources for the first time-domain unit according to the dynamic signaling and the SBFD pattern comprises at least one of the following:
the dynamic signaling is in a downlink control information (DCI) format 2_0, and the terminal determines whether a resource indicated by the SBFD pattern is available or not according to a transmission direction of the first time-domain unit configured by the semi-static signaling and indication of a format index in the dynamic signaling; and
the dynamic signaling is terminal dedicated DCI and/or an RRC message, and the terminal determines whether the resource indicated by the SBFD pattern is available or not according to a transmission direction of the first time-domain unit scheduled or configured by the dynamic signaling.

10. The method according to claim 9, wherein the operation that the terminal determines whether a resource indicated by the SBFD pattern is available or not according to a transmission direction of the first time-domain unit configured by the semi-static signaling and indication of a format index in the dynamic signaling comprises at least one of the following:
in a case that the first time-domain unit is configured into a downlink resource by the semi-static signaling, and the format index in the dynamic signaling indicates uplink, determining that an uplink sub-band indicated by the SBFD pattern is available;
in a case that the first time-domain unit is configured into the downlink resource by the semi-static signaling, and the format index in the dynamic signaling indicates downlink, determining that the uplink sub-band indicated by the SBFD pattern is unavailable;
in a case that the first time-domain unit is configured into the downlink resource by the semi-static signaling, and the format index in the dynamic signaling indicates a flexible resource F or a first value, determining that the uplink sub-band indicated by the SBFD pattern is unavailable;
in a case that the first time-domain unit is configured into the downlink resource by the semi-static signaling, and the format index in the dynamic signaling indicates the flexible resource F or the first value, determining that the uplink sub-band indicated by the SBFD pattern is available;
in a case that the first time-domain unit is configured into an uplink resource by the semi-static signaling, and the format index in the dynamic signaling indicates downlink, determining that a downlink sub-band indicated by the SBFD pattern is available;
in a case that the first time-domain unit is configured into the uplink resource by the semi-static signaling, and the format index in the dynamic signaling indicates uplink, determining that the downlink sub-band indicated by the SBFD pattern is unavailable;
in a case that the first time-domain unit is configured into the uplink resource by the semi-static signaling, and the format index in the dynamic signaling indicates the flexible resource F or the first value, determining that the downlink sub-band indicated by the SBFD pattern is unavailable;
in a case that the first time-domain unit is configured into the uplink resource by the semi-static signaling, and the format index in the dynamic signaling indicates the flexible resource F or the first value, determining that the uplink sub-band indicated by the SBFD pattern is available;
in a case that the first time-domain unit is configured into a flexible resource by the semi-static signaling, and the format index in the dynamic signaling indicates downlink, determining that the downlink sub-band indicated by the SBFD pattern is available;
in a case that the first time-domain unit is configured into the flexible resource by the semi-static signaling, and the format index in the dynamic signaling indicates downlink, determining that the downlink sub-band indicated by the SBFD pattern is unavailable;
in a case that the first time-domain unit is configured into the flexible resource by the semi-static signaling, and the format index in the dynamic signaling indicates downlink, determining that the resource indicated by the SBFD pattern is unavailable, and a downlink resource configured by a time division duplex uplink downlink common configuration signaling (TDD-UL-DL-ConfigCommon) and/or a time division duplex uplink downlink dedicated configuration signaling (TDD-UL-DL-ConfigDedicated) is available;
in a case that the first time-domain unit is configured into the flexible resource by the semi-static signaling, and the format index in the dynamic signaling indicates uplink, determining that the uplink sub-band indicated by the SBFD pattern is available;
in a case that the first time-domain unit is configured into the flexible resource by the semi-static signaling, and the format index in the dynamic signaling indicates uplink, determining that the uplink sub-band indicated by the SBFD pattern is unavailable;
in a case that the first time-domain unit is configured into the flexible resource by the semi-static signaling, and the format index in the dynamic signaling indicates uplink, determining that the resource indicated by the SBFD pattern is unavailable, and an uplink resource configured by the TDD-UL-DL-ConfigCommon and/or the TDD-UL-DL-ConfigDedicated is available;
in a case that the first time-domain unit is configured into the flexible resource by the semi-static signaling, and the format index in the dynamic signaling indicates the flexible resource F or the first value, determining that the uplink sub-band indicated by the SBFD pattern is available;
in a case that the first time-domain unit is configured into the flexible resource by the semi-static signaling, and the format index in the dynamic signaling indicates the flexible resource F or the first value, determining that the uplink sub-band indicated by the SBFD pattern is unavailable;
in a case that the first time-domain unit is configured into the flexible resource by the semi-static signaling, and the format index in the dynamic signaling indicates the flexible resource F or the first value, determining that the downlink sub-band indicated by the SBFD pattern is available;
in a case that the first time-domain unit is configured into the flexible resource by the semi-static signaling, and the format index in the dynamic signaling indicates the flexible resource F or the first value, determining that the downlink sub-band indicated by the SBFD pattern is unavailable;
in a case that the first time-domain unit is configured into the flexible resource by the semi-static signaling, and the format index in the dynamic signaling indicates the flexible resource F or the first value, determining that the resource indicated by the SBFD pattern is available; and
in a case that the first time-domain unit is configured into the flexible resource by the semi-static signaling, and the format index in the dynamic signaling indicates the flexible resource F or the first value, determining that the resource indicated by the SBFD pattern is unavailable, and a flexible resource configured by the TDD-UL-DL-ConfigCommon and/or the TDD-UL-DL-ConfigDedicated is available.

11. The method according to claim 9, wherein the operation that the terminal determines whether the resource indicated by the SBFD pattern is available or not according to a transmission direction of the first time-domain unit scheduled or configured by the dynamic signaling comprises at least one of the following:
in a case that uplink transmission is scheduled or configured by the dynamic signaling on an uplink sub-band indicated by the SBFD pattern, determining that the uplink sub-band indicated by the SBFD pattern is available;
in a case that downlink transmission is scheduled or configured by the dynamic signaling on the uplink sub-band indicated by the SBFD pattern, determining that the uplink sub-band indicated by the SBFD pattern is unavailable;
in a case that uplink transmission is scheduled or configured by the dynamic signaling on a downlink sub-band indicated by the SBFD pattern, determining that the downlink sub-band indicated by the SBFD pattern is unavailable; and
in a case that downlink transmission is scheduled or configured by the dynamic signaling on the downlink sub-band indicated by the SBFD pattern, determining that the downlink sub-band indicated by the SBFD pattern is available.

12. The method according to claim 4, wherein
the terminal is not expected to receive a first dynamic signaling and a second dynamic signaling, and for a same first time-domain unit, the first dynamic signaling indicates that the SBFD pattern configured for the first time-domain unit takes effect, and the second dynamic signaling indicates that the SBFD pattern configured for the first time-domain unit does not take effect;
or the method further comprises:
receiving, by the terminal, first indication information sent by the network side device, wherein the first indication information indicates reception of the dynamic signaling at a first time location; wherein
the determining, by the terminal, available resources for the first time-domain unit according to the dynamic signaling and the SBFD pattern comprises:
in a case that the dynamic signaling is not received at the first time location, determining, by the terminal, that the resource indicated by the SBFD pattern is available; or
determining, by the terminal, that the resource indicated by the SBFD pattern is unavailable; or
determining, by the terminal, whether the resource indicated by the SBFD pattern is available or not according to the dynamic signaling received at the last time; or
determining, by the terminal, that the resource indicated by the SBFD pattern is available or unavailable according to the configuration of the network side device.

13. A resource configuration method, comprising:
sending, by a network side device, sub-band full duplex (SBFD) configuration information to a terminal, wherein the SBFD configuration information comprises at least one of the following:
a quantity of SBFD patterns;
a time-domain period for applying SBFD pattern, wherein the time-domain period comprises at least one first time-domain unit;
whether each of the first time-domain unit is configured with an SBFD pattern or not in the time-domain period for applying SBFD pattern;
the SBFD pattern configured for each of the first time-domain unit in the time-domain period for applying SBFD pattern; and
a quantity of the first time-domain unit comprised in the time-domain period for applying SBFD pattern.

14. The method according to claim 13, wherein the time-domain period for applying SBFD pattern is determined by downlink-uplink-transmission periodicity (DL-UL-TransmissionPeriodicity) that is configured by the network side device.

15. The method according to claim 14, wherein in a case that one SBFD pattern is configured, the time-domain period for applying the SBFD pattern is a period indicated by DL-UL-TransmissionPeriodicity corresponding to the one SBFD pattern; and
in a case that two SBFD patterns are configured, the time-domain period for applying the SBFD pattern is a sum of periods indicated by DL-UL-TransmissionPeriodicity respectively corresponding to the two SBFD patterns.

16. The method according to claim 13, further comprising:
sending, by a network side device, a dynamic signaling to a terminal, wherein the dynamic signaling indicates whether a sub-band full duplex SBFD pattern, configured by the network side device for a first time-domain unit by a semi-static signaling, takes effect or not.

17. The method according to claim 13, wherein in the time-domain period for applying SBFD pattern, SBFD patterns configured for different first time-domain units are different or the same; or
a quantity X of slots or a quantity Y of symbols comprised by the first time-domain unit is configured by the network side device or defined by a protocol.

18. The method according to claim 16, wherein the method further comprises:
sending, by the network side device, first indication information to the terminal, wherein the first indication information indicates reception of the dynamic signaling at a first time location;
or wherein the sending, by the network side device, a dynamic signaling to the terminal comprises:
sending, by the network side device, a first dynamic signaling and a second dynamic signaling to the terminal, wherein the first dynamic signaling and the second dynamic signaling are not allowed to achieve the following effect: for a same first time-domain unit, the first dynamic signaling indicates that the SBFD pattern configured for the first time-domain unit takes effect, and the second dynamic signaling indicates that the SBFD pattern configured for the first time-domain unit does not take effect.

19. A terminal, comprising a processor and a memory, wherein the memory stores a program or instruction runnable on the processor, and when executed by the processor, the program or instruction implements a resource configuration method, the resource configuration method comprising:
receiving sub-band full duplex (SBFD) configuration information indicated by a network side device, wherein the SBFD configuration information comprises at least one of the following:
a quantity of SBFD patterns;
a time-domain period for applying SBFD pattern, wherein the time-domain period comprises at least one first time-domain unit;
whether each of the first time-domain unit is configured with an SBFD pattern or not in the time-domain period for applying SBFD pattern;
the SBFD pattern configured for each of the first time-domain unit in the time-domain period for applying SBFD pattern; and
a quantity of the first time-domain unit comprised in the time-domain period for applying SBFD pattern.

20. A network side device, comprising a processor and a memory, wherein the memory stores a program or instruction runnable on the processor, and when executed by the processor, the program or instruction implements the resource configuration method according to claim 13.
